(19) United States
(12) Patent Application Publication
(10) Pub. No.: US 2025/0211954 A1
(43) Pub. Date: Jun. 26, 2025

(54) INFORMATION PROCESSING APPARATUS, MOBILE BODY, AND RECORDING MEDIUM

(71) Applicant: TOYOTA JIDOSHA KABUSHIKI KAISHA, Toyota-shi (JP)

(72) Inventors: Takamasa HIGUCHI, Tokyo (JP); Jing MA, Kanagawa (JP); Xiao SHAO, Kanagawa (JP); Lei ZHONG, Tokyo (JP)

(73) Assignee: TOYOTA JIDOSHA KABUSHIKI KAISHA, Toyota-shi (JP)

(21) Appl. No.: 18/933,018

(22) Filed: Oct. 31, 2024

(30) Foreign Application Priority Data
Dec. 20, 2023 (JP) 2023-214959

(51) Int. Cl. H04W 4/46

(52) U.S. Cl. CPC H04W 4/46

(57) ABSTRACT

An information processing apparatus includes a processor that transmits, for each of one or more data blocks, a data block main body and a deletion timing to one or more first mobile bodies in such a way that the earlier the deletion timing of a data block, the greater the number of first mobile bodies as transmission destinations of the data block. The first mobile body transmits or receives one or more first data blocks among the one or more data block by inter-device communication, transmits a part or all of the one or more first data blocks that is received to another apparatus, and deletes the one or more first data blocks according to the deletion timings of each of the one or more first data blocks, depending on a remaining storage capacity.

### CROSS REFERENCE TO RELATED APPLICATION

This application claims the benefit of Japanese Patent Application No. 2023-214959, filed on Dec. 20, 2023, which is hereby incorporated by reference herein in its entirety.

### BACKGROUND

### Technical Field

The present disclosure relates to content distribution and data collection that use inter-device communication.

### Description of the Related Art

There is disclosed a technique according to which a plurality of distribution vehicles are caused to download, by cellular communication or the like, a plurality of pieces of fragment data obtained by dividing data content that is desired to be distributed, and to perform distribution by inter-vehicle communication when passing by a reception vehicle that needs the content on a road (for example, Non-Patent Document 1). The reception vehicle assembles the pieces of fragment data received from one or more distribution vehicles and performs a decoding process, and thus restores the original data content.
[Non-Patent Document 1] Maheswaran Sathiamoorthy, Alexandros G. Dimakis, Bhaskar Krishnamachari, Fan Bai, “Distributed Storage Codes Reduce Latency in Vehicular Networks”, IEEE Transactions on Mobile Computing, Jul. 30, 2014, vol. 13, no. 9, pp. 2016-2027

### SUMMARY

An aspect of the present disclosure is aimed at providing an information processing apparatus, a mobile body, and a recording medium that are capable of increasing reliability of content distribution or data collection that uses inter-device communication between mobile bodies.

An aspect of the present disclosure is an information processing apparatus comprising a processor configured to transmit, for each of one or more data blocks, a data block main body and a deletion timing to one or more first mobile bodies in such a way that the earlier the deletion timing of a data block, the greater the number of first mobile bodies as transmission destinations of the data block, wherein
each of the one or more first mobile bodies
   transmits or receives one or more first data blocks among the one or more data blocks by inter-device communication,
   transmits a part or all of the one or more first data blocks that is received to another apparatus, and
deletes the one or more first data blocks according to the deletion timings of each of the one or more first data blocks, depending on a remaining storage capacity.

Another aspect of the present disclosure is a mobile body comprising a processor configured to
transmit or receive one or more first data blocks by inter-device communication, and
transmit a part or all of the one or more first data blocks that is received from a transmission source apparatus to another apparatus, wherein
the processor
   receives a data block main body and a deletion timing for each of the one or more first data blocks, and
   deletes the one or more first data blocks according to the deletion timings of each of the one or more first data blocks, depending on a remaining storage capacity, and
the earlier the deletion timing of a first data block, the greater the number of mobile bodies to which the first data block is transmitted.

Another aspect of the present disclosure is a non-transitory computer-readable recording medium holding a program for causing a computer to transmit, for each of one or more data blocks, a data block main body and a deletion timing to one or more first mobile bodies in such a way that the earlier the deletion timing of a data block, the greater the number of first mobile bodies as transmission destinations of the data block, wherein
each of the one or more first mobile bodies
   transmits or receives one or more first data blocks among the one or more data blocks by inter-device communication,
   transmits a part or all of the one or more first data blocks that is received to another apparatus, and
   deletes the one or more first data blocks according to the deletion timings of each of the one or more first data blocks, depending on a remaining storage capacity.

According to the present disclosure, reliability of content distribution or data collection that uses inter-device communication between mobile bodies can be increased.

### BRIEF DESCRIPTION OF THE DRAWINGS

FIG. 1 is a diagram illustrating an example of a system configuration of a content distribution system according to a first embodiment;

FIG. 2 is a diagram illustrating an example of a hardware configuration of the distribution server and the distribution vehicle;

FIG. 3 is a diagram illustrating an example of a functional configuration of the distribution server;

FIG. 4 is a diagram illustrating an example of a functional configuration of the distribution vehicle;

FIG. 5 is a diagram illustrating an example of the estimation result for transition in the remaining storage capacity in the distribution vehicle;

FIG. 6 is an example of a flowchart of a process by the distribution server;

FIG. 7 is an example of a flowchart of a storage capacity profile generation process by the distribution vehicle;

FIG. 8 is an example of a flowchart of a content management process by the distribution vehicle;

FIGS. 9A and 9B are diagrams illustrating an example of a sequence of a content distribution process of the content distribution system;

FIG. 10 is a diagram illustrating an example of a system configuration of a data collection system according to a second embodiment;

FIG. 11 is a diagram illustrating an example of a functional configuration of the source vehicle;

FIG. 12 is a diagram illustrating an example of a functional configuration of the sink vehicle;

FIG. 13 is an example of a flowchart of an upload data transmission process by the source vehicle; and

FIGS. 14A and 14B are diagrams illustrating an example of a sequence of an upload data collection process of the data collection system.

### DESCRIPTION OF THE EMBODIMENTS

In the case where a plurality of distribution vehicles are caused to download data content by cellular communication or the like, and to perform distribution by inter-vehicle communication when passing by a reception vehicle, the distribution vehicles are caused to store the data content in a storage unit (a storage). For example, the data content is divided into pieces of fragment data depending on a size. A distribution vehicle not having enough free space in the storage is sometimes not able to store an enough number of pieces of fragment data to restore the original data content. As a result, there is a high possibility that the reception vehicle is not able to complete acquisition of an enough number of pieces of fragment data for restoring the original data by inter-vehicle communication with one distribution vehicle.

Moreover, the storage in the distribution vehicle is used also by other application programs, and thus, when the free space in the storage is reduced, the fragment data is possibly deleted. In the case where, as described above, an enough number of pieces of fragment data for restoring the original data content is not acquired from the distribution vehicle, the reception vehicle sometimes acquires one or more missing pieces of fragment data from a server holding the original data content by cellular communication, for example. In the following, the data content will be simply referred to as content.

In view of the problem described above, in an aspect of the present disclosure, a data block is transmitted to at least one distribution vehicle in such a way that the shorter a holding time of a data block in a distribution vehicle, the greater the number of distribution vehicles in which the data block is held. Accordingly, opportunity for distribution becomes more equal among data blocks regardless of the holding time in the distribution vehicle, and reliability of distribution of content to a reception vehicle can be increased.

More specifically, an aspect of the present disclosure is an information processing apparatus including a processor configured to transmit, for each of one or more data blocks, a data block main body and a deletion timing to one or more first mobile bodies in such a way that the earlier the deletion timing of a data block, the greater the number of first mobile bodies as transmission destinations of the data block. The first mobile body may transmit or receive one or more first data blocks among the one or more data blocks by inter-device communication, transmit a part or all of the one or more first data blocks that is received to another apparatus, and delete the one or more first data blocks according to the deletion timings of each of the one or more first data blocks, depending on a remaining storage capacity.

For example, the information processing apparatus may be a server that controls a distribution vehicle and a reception vehicle in a system where the distribution vehicle is caused to distribute content to the reception vehicle by inter-vehicle communication, or an in-vehicle apparatus that is mounted in a source vehicle in a system where a sink vehicle is caused to collect data generated by the source vehicle by inter-vehicle communication. However, the information processing apparatus is not limited to such examples, and the information processing apparatus may be a mobile terminal such as a computer mounted in a mobile body other than a vehicle, a smartphone, a tablet terminal, and a personal computer (PC), for example. The processor may be a processor such as a central processing unit (CPU), a graphics processing unit (GPU), and a digital signal processor (DSP), for example. However, the processor is not limited to be a processor, and may instead be a circuit such as a field programmable gate array (FPGA), an integrated circuit (IC), and a complex programmable logic device (CPLD), for example.

The mobile body may be a vehicle such as a car, a motorcycle and a train, a ship, and an aircraft, for example. Furthermore, the mobile body may be a smartphone, a tablet terminal, a PC, and a portable game console, for example. The first mobile body may be the distribution vehicle that distributes content to the reception vehicle, or the sink vehicle that collects data from the source vehicle, for example.

The data block may be a distribution content main body, a pieces of fragment data of the distribution content, a collection target data main body, or a pieces of fragment data of the collection target data, for example. The distribution content may be an update program for a predetermined program, for example. The collection target data may be sensor data including a detection value of a sensor, for example. The sensor data may be position information, speed information, and a captured image from a camera, for example. However, the distribution content, the collection target data, and the sensor data are not limited to such examples.

The deletion timing may indicate a place in an order of deletion from a storage in the first mobile body in a case where there is not enough remaining storage capacity in the first mobile body, for example. The deletion timing may be expressed by a number, a level, a degree of priority, a priority ranking, or a estimated time of holding of a data block in the mobile body that is the transmission destination, for example. In the case where there are two levels for indicating the deletion timing, namely, an early deletion timing and a late deletion timing, for example, the level is information indicating one of the levels to which the data block is sorted. Additionally, even when there is only one data block, the deletion timing is determined for the one data block.

Inter-device communication is a communication method that allows inter-terminal communication, such as inter-vehicle wireless LAN communication, dedicated short-range communications (DSRC), 5G sidelink communication, device-to-device (D2D) communication, and ad hoc mode WiFi communication, for example. However, inter-device communication is not limited to such examples.

According to an aspect of the present disclosure, the earlier the deletion timing of a data block, the greater the number of first mobile bodies to which the data block is transmitted. Accordingly, even if a time when a data block with an early deletion timing is held in a plurality of first mobile bodies as the transmission destinations is short, chances of a first mobile body holding the data block with an early deletion timing passing by an apparatus that is to receive the data block are increased. For example, in a system where a distribution vehicle is caused to distribute the content to a reception vehicle by inter-vehicle communication, a data block with an early deletion timing is transmitted to a greater number of distribution vehicles, and thus, chances of the reception vehicle passing by a distribution vehicle holding the data block with an early deletion timing are increased. Accordingly, the reception timing is more likely to be able to acquire the data block with an early deletion timing before deletion, and reliability of distribution of the content to the reception vehicle can be increased. Moreover, a time length until acquisition of data blocks to restore the content can be reduced.

For example, in the system where the sink vehicle is caused to collect data generated by the source vehicle by inter-vehicle communication, a data block with an early deletion timing is transmitted from the source vehicle to a greater number of sink vehicles. Accordingly, upload of a data block with an early deletion timing to a data collection server is more likely to be completed before the data block is deleted from the sink vehicle, and reliability of data collection is increased.

In an aspect of the present disclosure, the processor may transmit, for each of the one or more data blocks, to such a number of first mobile bodies that a total value of a first time length in the one or more first mobile bodies as the transmission destinations is approximately same between data blocks with different deletion timings. The first time length is time length that a data block is held in a first mobile body. In this case, the first time length is shorter when the deletion timing of the data block is earlier. For example, in the case where the first time length for a data block A with an early deletion timing is 30 minutes, and the first time length for a data block B with a late deletion timing is 5 hours, if the data block B is to be transmitted to M first mobile bodies, the processor transmits the data block A to 10×M first mobile bodies. Accordingly, the total value of the first time length that the data block is held in the first mobile bodies as the transmission destinations is 5×M hours for both the data block A and the data block B.

According to an aspect of the present disclosure, chances of reception of data from a first mobile body holding a data block may be made approximately equal among data blocks regardless of the deletion timings. For example, in the system where the distribution vehicle is caused to distribute the content to the reception vehicle by inter-vehicle communication, a possibility of the reception vehicle completing reception of a data block with an early deletion timing before receiving a data block with a late deletion timing from a distribution vehicle can be increased. Accordingly, a time length until the reception vehicle acquires the distribution content can be reduced.

In an aspect of the present disclosure, the processor may estimate, for each of the one or more data blocks, the first time length in each of the one or more first mobile bodies, based on a size of a data block, the deletion timing of the data block, and estimation information about transition in the remaining storage capacity on each of the one or more first mobile bodies. The estimation information about transition in the remaining storage capacity on the first mobile body may be received from the first mobile body. The transition in the remaining storage capacity is different for each first mobile body. In an aspect of the present disclosure, the first time length can be more accurately estimated, and thus, the number of first mobile bodies as transmission destinations of a data block with an early deletion timing may take an appropriate value according to the manner of deletion of the data block.

In another aspect, the present disclosure may be specified as a mobile body including a processor that is configured to transmit or receive one or more first data blocks by inter-device communication, and transmit a part or all of the one or more first data blocks that is received from a transmission source apparatus to another apparatus. The processor may receive a data block main body and a deletion timing for each of the one or more first data blocks, and may delete the one or more first data blocks according to the deletion timings of each of the one or more first data blocks, depending on a remaining storage capacity. The earlier the deletion timing of a first data block, the greater the number of mobile bodies to which the first data block may be transmitted. The mobile body may be a distribution vehicle in the system where a distribution vehicle is caused to distribute the content to a reception vehicle by inter-vehicle communication, or an in-vehicle apparatus that is mounted in a sink vehicle in the system where a sink vehicle is caused to collect data generated by a source vehicle by inter-vehicle communication, for example. In another aspect of the present disclosure, the mobile body deletes the data block according to the deletion timing, and thus, it may be reduced that the data block occupies a storage capacity for a long period of time.

In other aspects, the present disclosure may be specified to be a method executed by a computer to perform a process that is performed by the information processing apparatus described above, a program for causing the computer to perform the method, and a non-transitory computer-readable recording medium storing the program.

In the following, embodiments of the present disclosure will be described with reference to the drawings. The configuration of the embodiments described below are examples, and the present disclosure is not limited to the configuration of the embodiments.

### First Embodiment

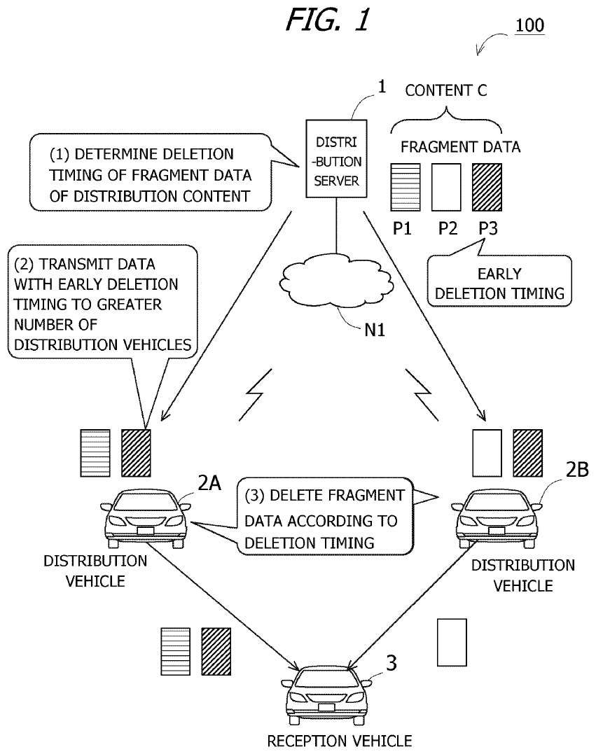

FIG. 1 is a diagram illustrating an example of a system configuration of a content distribution system 100 according to a first embodiment. The content distribution system 100 is a system that causes a vehicle to distribute predetermined content to another vehicle by inter-vehicle communication. The content distribution system 100 includes a distribution server 1, a distribution vehicle 2 that receives content from the distribution server 1 and distributes the content to another vehicle by inter-vehicle communication, and a reception vehicle 3 that receives the content from the distribution vehicle 2 by inter-vehicle communication. Additionally, a plurality of distribution vehicles 2 and a plurality of reception vehicles 3 are included in the content distribution system 100, and a distribution vehicle 2A, a distribution vehicle 2B, and a reception vehicle 3 are illustrated in FIG. 1 as representatives. When not distinguishing between each other, simple terms “distribution vehicle(s) 2” and “reception vehicle(s) 3” will be used. An in-vehicle apparatus including a communication function is mounted in the distribution vehicle 2 and the reception vehicle 3. In the following, actual main performers of communication by the distribution vehicle 2 and the reception vehicle 3 are the in-vehicle apparatuses, but for the sake of convenience, a description will be given assuming that the main performers are the distribution vehicle 2 and the reception vehicle 3.

The distribution server 1, the distribution vehicle 2, and the reception vehicle 3 are connected to a network N1, and are capable of communicating with one another via the network N1. For example, the network N1 is a public network such as the Internet. The distribution vehicle 2 and the reception vehicle 3 are capable of connecting to the network N1 via a cellular network or a wireless LAN as an access network.

The distribution server 1 is a server that holds original data of content that is to be distributed to a vehicle, selects a distribution vehicle 2, and transmits the content to the distribution vehicle 2. The distribution server 1 divides the content into pieces of fragment data, and transmits the one or more pieces of the fragment data to the distribution vehicle 2. The distribution vehicle 2 downloads one or more pieces of the fragment data from the distribution server 1, and saves one or more pieces of the fragment data in a storage in the in-vehicle apparatus. When passing by a reception vehicle 3 on a road, the distribution vehicle 2 transmits one or more pieces of the fragment data to the reception vehicle 3 by inter-vehicle communication. The distribution vehicle 2 itself may, but does not have to, be a distribution destination of content, or in other words, the reception vehicle 3. The reception vehicle 3 is a vehicle that is a distribution destination of content. When the reception vehicle 3 acquires content from the distribution vehicle 2 by inter-vehicle communication, a bandwidth in use for cellular communication may be reduced or a communication cost may be suppressed. In the first embodiment, inter-vehicle communication may be inter-vehicle wireless LAN communication, DSRC, or 5G sidelink communication, for example. In the following, it is assumed that referring to “fragment data” stands for “one piece of fragment data.”

First, a flow of distribution of content by inter-vehicle communication will be described. The distribution server 1 holds content C that is a distribution target, and divides the content C into one or more pieces of fragment data according to a data size, for example. In FIG. 1, the content C is divided into fragment data P1, P2, and P3. The distribution vehicle 2 is a vehicle that distributes one or more pieces of the fragment data to the reception vehicle 3 by inter-vehicle communication. The distribution vehicle 2 is designated by the distribution server 1. The distribution vehicle 2 downloads and acquires one or more pieces of the fragment data from the distribution server 1 through cellular communication or wireless LAN communication, for example.

The reception vehicle 3 is a vehicle that is a distribution target of the content C. The distribution server 1 transmits a content acquisition instruction to the reception vehicle 3. Additionally, it is possible to distribute different content to a plurality of reception vehicles 3 by one content acquisition instruction.

When passing by one of the distribution vehicles 2 on a road, the reception vehicle 3 performs inter-vehicle communication with the distribution vehicle 2. In the case where the distribution vehicle 2 that is a counterpart of inter-vehicle communication holds the one or more pieces of fragment data that is specified by the content acquisition instruction, the reception vehicle 3 requests the distribution vehicle 2 by inter-vehicle communication for one or more pieces of the fragment data that is not yet obtained and acquires the piece(s) of the fragment data. In FIG. 1, the reception vehicle 3 first acquires the fragment data P1 and P3 from the distribution vehicle 2A, and then acquires the fragment data P2 from the distribution vehicle 2B.

The reception vehicle 3 saves the acquired piece(s) of fragment data in the storage in the in-vehicle apparatus. When acquisition of the fragment data P1, P2, and P3 is complete, the reception vehicle 3 restores the content C by using the fragment data P1, P2, and P3, and decoding information included in the content acquisition instruction from the distribution server 1. In the case where the decoding information includes a checksum, the reception vehicle 3 may calculate a hash value of a decoding result and check the same against the checksum to check whether the decoding result matches the original content C.

In the first embodiment, (1) the distribution server 1 determines a deletion timing of the fragment data for when a remaining storage capacity in the distribution vehicle 2 becomes insufficient. This is to prevent the distribution content from occupying the storage in the distribution vehicle 2 and from preventing other application programs from using the storage.
(2) The earlier deletion timing with fragment data, the greater number of distribution vehicles 2 the distribution server 1 transmits the fragment data to. At this time, the distribution server 1 transmits the deletion timing to the distribution vehicle 2 together with the fragment data. For example, in FIG. 1, the fragment data P3 has an earlier deletion timing than the fragment data P1 and P2, and thus, the fragment data P3 is transmitted to (downloaded by) both the distribution vehicle 2A and the distribution vehicle 2B. Accordingly, the reception vehicle 3 may acquire the fragment data P3 from either of the distribution vehicle 2A and the distribution vehicle 2B, and chances of acquisition of the fragment data P3 are increased. Accordingly, even when the deletion timing of the fragment data P3 is early, or in other words, a time when the fragment data P3 is held in the distribution vehicle 2 is short, a possibility of the reception vehicle 3 completing acquisition of the fragment data P3 before the fragment data P3 is deleted can be increased. By contrast, the deletion timings of the fragment data P1 and P2 are late and the fragment data P1 and P2 are held in the distribution vehicle 2 longer than the fragment data P3, and thus, the reception vehicle 3 is sufficiently capable of passing by the distribution vehicle 2A and the distribution vehicle 2B and of acquiring the fragment data P1 and P2 by inter-vehicle communication before deletion.
(3) The distribution vehicle 2 deletes, when the remaining storage capacity becomes insufficient, from fragment data with an early deletion timing. Accordingly, exertion of pressure on the storage capacity in the distribution vehicle 2 by distribution content may be prevented. For its part, fragment data with a late deletion timing is held by the distribution vehicle 2 for a longer period of time. Accordingly, the storage in the distribution vehicle 2 may be dynamically used as a short-term cache and a long-term cache without securing, in the storage in the distribution vehicle 2, a short-term cache for holding the fragment data for about 30 minutes to one hour and a long-term cache for holding the fragment data in units of hours.

One piece of fragment data is an example of “data block”. The distribution vehicle 2 is an example of “first mobile body”. The in-vehicle apparatus mounted in the reception vehicle 3 is an example of “another apparatus”. Inter-vehicle communication is an example of “inter-device communication”. The distribution server 1 is an example of “information processing apparatus”.

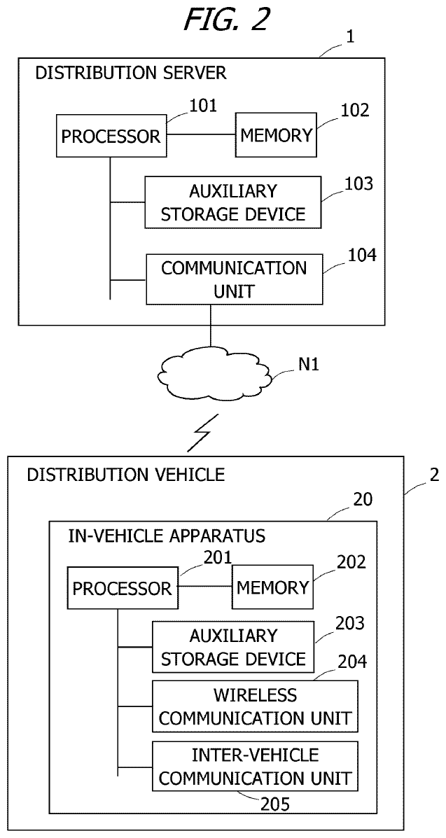

FIG. 2 is a diagram illustrating an example of a hardware configuration of the distribution server 1 and the distribution vehicle 2. The distribution server 1 can be an information processing apparatus (computer) such as a server machine. The distribution server 1 may instead be a collection (cloud) of one or more computers. Additionally, the distribution server 1 may be an apparatus including an electric circuit such as a field-programmable gate array (FPGA) or an application specific integrated circuit (ASIC) dedicated to execution of a corresponding process.

As hardware components, the distribution server 1 includes a processor 101, a memory 102, an auxiliary storage device 103, and a communication unit 104. The memory 102 and the auxiliary storage device 103 are computer-readable recording media. The processor 101, the auxiliary storage device 103, and the communication unit 104 are electrically connected by a bus.

The auxiliary storage device 103 stores various programs, and data to be used by the processor 101 at the time of execution of each program. For example, the auxiliary storage device 103 is an erasable programmable ROM (EPROM), a hard disk drive, or a solid state drive (SSD). Programs to be stored in the auxiliary storage device 103 include an operating system (OS), and a control program of the content distribution system 100, for example.

The memory 102 is a main memory that provides the processor 101 with a work area and a memory area for loading a program stored in the auxiliary storage device 103, and that is used as a buffer. For example, the memory 102 includes a semiconductor memory such as a read only memory (ROM) or a random access memory (RAM).

The processor 101 performs a process by loading, into the memory 102, and executing the OS held in the auxiliary storage device 103 and the control program of the content distribution system 100. The processor 101 is a CPU, a GPU, or a digital signal processor (DSP), for example. The number of processors 101 is not limited to one, and there may be more than one processor 101. The processor 101 is an example of “processor”.

For example, the communication unit 104 is a network interface card (NIC) or an optical line interface. Additionally, the communication unit 104 may be a wireless communication circuit that connects to a wireless network such as a wireless LAN, for example. Additionally, the hardware configuration of the distribution server 1 is not limited the one illustrated in FIG. 2.

The distribution vehicle 2 includes an in-vehicle apparatus 20. The in-vehicle apparatus 20 is a data communication apparatus (data communication module), a car navigation system, or a dashboard camera, for example. Additionally, the distribution vehicle 2 includes hardware components other than the in-vehicle apparatus 20, but FIG. 2 describes, as a representative example, the in-vehicle apparatus 20, which is a hardware element that is related to processing by the content distribution system 100, among hardware elements of the distribution vehicle 2. As hardware components, the in-vehicle apparatus 20 includes a processor 201, a memory 202, an auxiliary storage device 203, and a wireless communication unit 204. The processor 201, the memory 202, and the auxiliary storage device 203 are the similar as the processor 101, the memory 102, and the auxiliary storage device 103. However, the auxiliary storage device 203 stores a control program for controlling operation of the distribution vehicle 2, in addition to the OS and the like. Moreover, the auxiliary storage device 203 is a “storage”, and is also used as a cache for holding the fragment data.

The wireless communication unit 204 is a wireless communication circuit that is compatible with a mobile communication method such as 5G, 4G or 6G, or a wireless communication method such as WiFi, for example. In the first embodiment, the distribution vehicle 2 connects to the network N1 through the wireless communication unit 204, and acquires one or more pieces of the fragment data from the distribution server 1. For example, an inter-vehicle communication unit 205 is a wireless communication circuit that is compatible with an inter-vehicle communication method such as inter-vehicle wireless LAN communication, DSRC, or 5G sidelink communication. In the first embodiment, the distribution vehicle 2 transmits one or more pieces of the fragment data to the reception vehicle 3 through the inter-vehicle communication unit 205. Additionally, the hardware configuration of the in-vehicle apparatus 20 is not limited to the one illustrated in FIG. 2. Additionally, the in-vehicle apparatus mounted in the reception vehicle 3 has the similar hardware configuration as the hardware configuration of the in-vehicle apparatus 20 illustrated in FIG. 2.

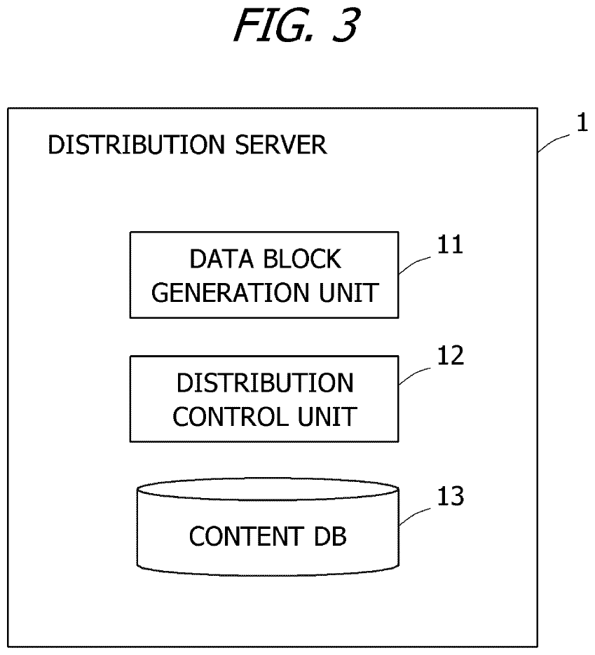

FIG. 3 is a diagram illustrating an example of a functional configuration of the distribution server 1. As functional components, the distribution server 1 includes a data block generation unit 11, a distribution control unit 12, and a content DB 13. The data block generation unit 11, the distribution control unit 12, and the content DB 13 are functional components that are implemented through execution of the control program of the content distribution system 100 by the processor 101 of the distribution server 1, for example. However, each of the data block generation unit 11, the distribution control unit 12, and the content DB 13 may instead be implemented by a hardware components such as an FPGA.

The content DB 13 holds original data of the distribution content. The content DB 13 is created in a memory area in the auxiliary storage device 103. The data block generation unit 11 divides the content and generates one or more pieces of fragment data. For example, the data block generation unit 11 may generate a plurality of pieces of fragment data by dividing the content in such a way that each piece of the fragment data has a predetermined size, or may generate a plurality of pieces of fragment data by dividing the content by using a coding technique such as an erasure correction code. In the case where the plurality of pieces of fragment data is created using the erasure correction code, the reception vehicle 3 can restore the original content by acquiring a predetermined number of pieces of fragment data without acquiring all the pieces of fragment data generated from the content. Additionally, for example, in the case where a size of the content is small, the content does not have to be divided. In this case, processing is performed by assuming that the number of pieces of fragment data is one.

The distribution control unit 12 performs selection and designation of the distribution vehicle 2, transmission of the content acquisition instruction to the reception vehicle 3, determination of the deletion timing of a piece of the fragment data for when the remaining storage capacity in the distribution vehicle 2 becomes insufficient ((1) in FIG. 1), and selection of the distribution vehicle 2 as the transmission destination of the piece of the fragment data (2) in FIG. 1).

For example, the distribution control unit 12 selects the distribution vehicle 2 from among vehicles managed by the content distribution system 100, according to a predetermined rule. For example, the distribution control unit 12 may designate, as the distribution vehicle 2, an electric vehicle that is connected to a nearby WiFi access point during charging, based on a notification from the electric vehicle. Alternatively, the distribution control unit 12 may actively select a part of traveling vehicles as the distribution vehicle 2. The distribution control unit 12 may select the distribution vehicles 2 in such a way that a density of the distribution vehicles 2 is geographically uniform, and may thus increase efficiency of content distribution.

For example, the distribution control unit 12 notifies the distribution vehicle 2 that the distribution vehicle 2 is selected as the distribution vehicle, through transmission of a notification of designation as distribution vehicle or through push-transmission of the fragment data. In the first embodiment, it is assumed that the distribution vehicle 2 is notified that the distribution vehicle 2 is selected as the distribution vehicle, through transmission of the notification of designation as distribution vehicle. Additionally, the distribution vehicle 2 may be newly selected every time content is distributed, or may be newly selected every predetermined period such as once a day, for example. In the first embodiment, it is assumed that selection is newly performed each time content is distributed.

In the first embodiment, upon reception of the notification of designation as distribution vehicle, the distribution vehicle 2 transmits a storage capacity profile to the distribution server 1. The storage capacity profile is information about transition in the remaining storage capacity in the distribution vehicle 2. Details of the storage capacity profile will be given later.

The distribution control unit 12 determines, for each piece of fragment data generated by the data block generation unit 11, the deletion timing of a piece of the fragment data for when the remaining storage capacity in the distribution vehicle 2 becomes insufficient ((1) in FIG. 1). The deletion timing of a piece of the fragment data may be sorted into one of two stages, namely, early or late, or may be sorted into one of three or more levels. Alternatively, the deletion timing of a piece of the fragment data may be in accordance with a degree of priority of the piece of the fragment data. An earlier deletion timing may be indicated by a greater degree of priority, or an earlier deletion timing may be indicated by a smaller degree of priority. The deletion timing of a piece of the fragment data is determined based on a type of the content, a vehicle type of a vehicle that is a distribution destination, and the like, for example. The deletion timings of a plurality of pieces of fragment data included in the same content may be the same or different. The deletion timing may be indicated by any of information indicating the level into which a piece of the fragment data is sorted, a number indicating the deletion timing, the degree of priority, or the like. In the following, the deletion timing of a piece of the fragment data for when the remaining storage capacity in the distribution vehicle 2 becomes insufficient will be simply referred to as the deletion timing.

The distribution control unit 12 estimates a time length when each piece of fragment data is held in the storage in the distribution vehicle 2, based on the storage capacity profile from the distribution vehicle 2 and the deletion timing and a data size of each piece of fragment data, and determines the distribution vehicle 2 that is to be the transmission destination of each piece of fragment data based on the estimated time length ((2) in FIG. 1). At this time, the distribution control unit 12 determines the distribution vehicle that is to be the distribution destination of each piece of fragment data in such a way that the piece of fragment data with an early deletion timing is transmitted to a greater number of distribution vehicles 2. Details of the process of determining the distribution vehicle 2 that is to be the transmission destination of a piece of the fragment data will be given later. The distribution control unit 12 transmits, to one or more distribution vehicles 2 determined as the transmission destination of a piece of fragment data, identification information of the piece of the fragment data, a main body of the piece of the fragment data, and the deletion timing of the piece of the fragment data.

The distribution control unit 12 specifies the reception vehicle 3 based on details of content to be distributed, and transmits the content acquisition instruction to the reception vehicle 3. For example, the content acquisition instruction includes identification information of each piece of fragment data that is an acquisition target of the reception vehicle 3 and decoding information. The decoding information is information that is used to restore the original content C from the pieces of the fragment data. For example, the decoding information is a decoding parameter, a checksum for checking consistency with the original content, or the like. For example, in the case where pieces of the fragment data are generated by an erasure correction code, the decoding parameter includes the number of pieces of fragment data to restore the original content, and the like. When the content acquisition instruction is received, the reception vehicle 3 starts a process of acquiring, by inter-vehicle communication, one or more pieces of the fragment data specified by the content acquisition instruction from the distribution vehicle 2 that passes by. Additionally, the functional configuration of the distribution server 1 illustrated in FIG. 3 is merely an example, and the functional configuration of the distribution server 1 is not limited to the example illustrated in FIG. 3.

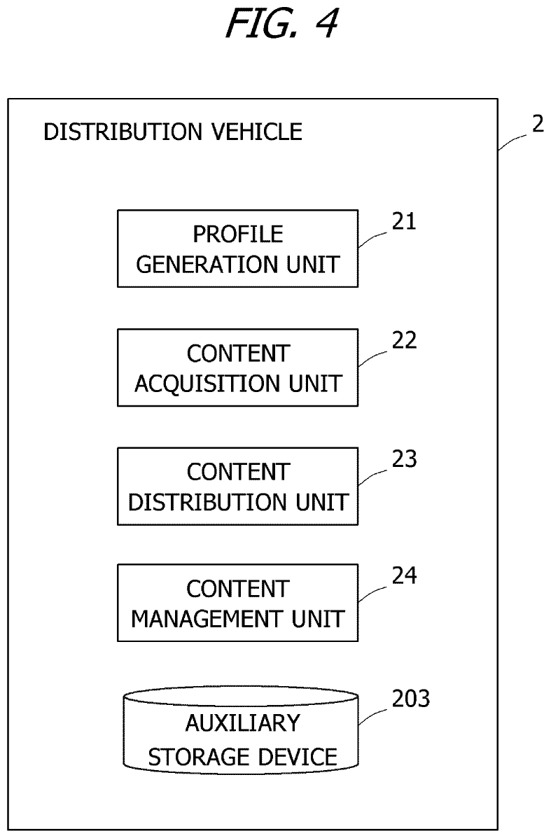

FIG. 4 is a diagram illustrating an example of a functional configuration of the distribution vehicle 2. As functional components, the distribution vehicle 2 includes a profile generation unit 21, a content acquisition unit 22, a content distribution unit 23, and a content management unit 24. Processes performed by these functional elements are implemented by the processor 201 of the in-vehicle apparatus 20 executing predetermined programs held in the auxiliary storage device 203. However, each of the profile generation unit 21, the content acquisition unit 22, the content distribution unit 23, and the content management unit 24 may instead be implemented by a hardware element such as an FPGA.

In the first embodiment, when the notification of designation as distribution vehicle is received from the distribution server 1, the profile generation unit 21 generates the storage capacity profile and transmits the storage capacity profile to the distribution server 1. For example, the storage capacity profile is transmitted through cellular communication or wireless LAN communication. In the case where notification of selection as the distribution vehicle is to be performed by push-transmission of one or more pieces of fragment data, the profile generation unit 21 may generate the storage capacity profile and transmit the storage capacity profile to the distribution server 1 when one or more pieces of the fragment data is received. Details of the process of generation of the storage capacity profile will be given later.

In the first embodiment, the content acquisition unit 22 receives one or more pieces of the fragment data from the distribution server 1. The identification information and the deletion timing of one or more pieces of the fragment data are also received together with one or more pieces of the fragment data. The content acquisition unit 22 stores the acquired piece(s) of the fragment data in the auxiliary storage device 203. One or more pieces of the fragment data may instead be acquired by the content acquisition unit 22 transmitting a request to the distribution server 1 and performing download from the distribution server 1. In this case, the distribution server 1 may notify the distribution vehicle 2 that is determined as the transmission destination of the fragment data, of one or more pieces of the fragment data as the acquisition target, together with an instruction to perform download. In the case where notification of designation as distribution vehicle is performed by push-transmission of one or more pieces of fragment data, the content acquisition unit 22 receives the identification information and the deletion timing of one or more pieces of the fragment data together with one or more pieces of the fragment data, and stores the same in the auxiliary storage device 203.

The content distribution unit 23 distributes one or more pieces of the fragment data to the reception vehicle 3. More specifically, when a request for a list of pieces of fragment data that are held is received from the reception vehicle 3 by inter-vehicle communication, the content distribution unit 23 creates a list of pieces of fragment data that are held in the auxiliary storage device 203, and transmits the list to the reception vehicle 3. When a request for acquisition of fragment data is received from the reception vehicle 3, the content distribution unit 23 reads out from the auxiliary storage device 203 one or more pieces of fragment data matching the identification information of one or more pieces of the fragment data that is the acquisition target of the reception vehicle 3 that is received together with the request, and transmits one or more pieces of the fragment data to the reception vehicle 3 by inter-vehicle communication.

The content management unit 24 manages one or more pieces of the fragment data that is held in the auxiliary storage device 203. More specifically, when the remaining capacity of the auxiliary storage device 203 falls below a first threshold, the content management unit 24 deletes, from the auxiliary storage device 203, one or more pieces of the fragment data with an earliest deletion timing among one or more pieces of the fragment data that are held in the auxiliary storage device 203. In the following, the remaining capacity of the auxiliary storage device 203 will be referred to as a remaining storage capacity. The content management unit 24 may keep deleting pieces of fragment data with the earliest deletion timing from the auxiliary storage device 203 until the remaining storage capacity becomes equal to or greater than a second threshold. The second threshold is a value that is equal to or greater than the first threshold.

Furthermore, in the case where there is a plurality of pieces of fragment data with the earliest deletion timing among pieces of the fragment data held in the auxiliary storage device 203, the content management unit 24 may delete all pieces of the fragment data with the earliest deletion timing from the auxiliary storage device 203, or may keep deleting one or more pieces of the fragment data with the earliest deletion timing from the auxiliary storage device 203 until the remaining storage capacity becomes equal to or greater than the second threshold, for example. Additionally, the functional configuration of the distribution vehicle 2 is not limited to the example illustrated in FIG. 4.

### (Storage Capacity Profile Generation Process)

In the first embodiment, the profile generation unit 21 of the distribution vehicle 2 generates the storage capacity profile when the notification of designation as distribution vehicle is received from the distribution server 1. The storage capacity profile is generated by the profile generation unit 21 analyzing a history of the remaining storage capacity, and estimating transition in the remaining storage capacity for a predetermined period of time in the future, and including a estimation result in. The history of the remaining storage capacity is time-series data of the remaining capacity of the storage. A estimation period of time for the remaining storage capacity is freely set to between three to ten hours, for example. Furthermore, in the case where the distribution vehicle 2 is parked, a timing when the distribution vehicle 2 starts to move next may be taken as a start point of the estimation period of time for the remaining storage capacity.

Generally, transition in the remaining storage capacity is expected to follow a pattern corresponding to an application operating on the in-vehicle apparatus 20. Transition in the remaining storage capacity will be described taking as an example a video collection application that saves, during traveling, measurement data from an in-vehicle sensor, such as video data from an in-vehicle camera, in a storage, and that collectively uploads the measurement data to a remote server from a nearby WiFi access point during parking. In this case, the remaining storage capacity in the in-vehicle apparatus 20 is expected to be reduced at a predetermined rate from a time point of activation of a vehicle system. When the in-vehicle apparatus 20 connects to a WiFi access point and upload of video data is completed, the uploaded video data is deleted from the storage, and the remaining storage capacity is recovered.

With the actual in-vehicle apparatus 20, a plurality of applications share the storage, and thus, a fluctuation pattern of the remaining storage capacity is highly likely more complicated, but estimation is possible as long as a change in the remaining storage capacity follows a reproducible pattern. The profile generation unit 21 may perform estimation of transition in the remaining storage capacity by using a regression model, a machine learning model, or the like. A method for estimating transition in the remaining storage capacity by the profile generation unit 21 is not limited to a specific method. The estimation result for transition in the remaining storage capacity may take a single estimation value, or may be expressed in the form of confidence interval or probability distribution. The profile generation unit 21 generates the storage capacity profile based on the estimation result for transition in the remaining storage capacity, and transmits the storage capacity profile to the distribution server 1. The storage capacity profile may include, in addition to the estimation result for transition in the remaining storage capacity, the estimation period of time, maximum capacity of the storage, and the like.

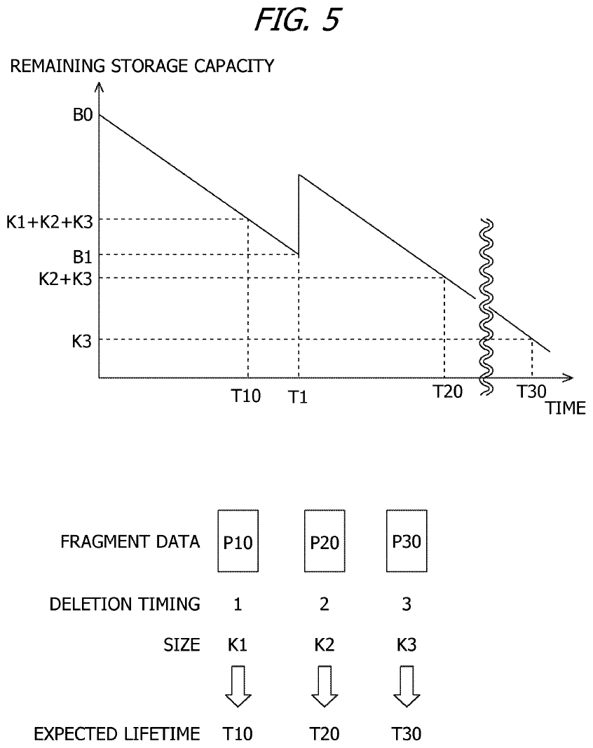

FIG. 5 is a diagram illustrating an example of the estimation result for transition in the remaining storage capacity in the distribution vehicle 2. A horizontal axis of a graph illustrated in FIG. 5 indicates an elapsed time, and a vertical axis indicates a estimated value of the remaining storage capacity. In the example illustrated in FIG. 5, the remaining storage capacity is B0 at a time point 0. Then, at a time point after a lapse of a time T1, the remaining storage capacity is reduced to B1, and is increased again due to the memory area being released due to end of execution of an application, for example. Then, the remaining storage capacity is estimated to decrease again. The profile generation unit 21 of the distribution vehicle 2 generates the storage capacity profile including the estimation result for transition in the remaining storage capacity as illustrated in FIG. 5, for example, and transmits the storage capacity profile to the distribution server 1. Additionally, the estimation result for transition in the remaining storage capacity that is included in the storage capacity profile may be a function, or may be a graph as illustrated in FIG. 5. The storage capacity profile is an example of “estimation information about transition in the remaining storage capacity”.

### (Fragment Data Transmission Destination Determination Process)

The distribution control unit 12 of the distribution server 1 determines the transmission destinations of fragment data based on the deletion timing and a time length of being held in the storage in the distribution vehicle 2 that are associated with the fragment data. In the first embodiment, the distribution control unit 12 estimates the time length when fragment data is held in the storage in the distribution vehicle 2, based on the size and the deletion timing of the fragment data, and the storage capacity profile notified from the distribution vehicle 2. In the following, a estimated value of the time length when fragment data is held in the storage in the distribution vehicle 2 will be referred to as an “expected lifetime” of the fragment data. Accordingly, the distribution control unit 12 first acquires the expected lifetime of each piece of fragment data in each distribution vehicle 2, and then, determines the transmission destinations of each piece of the fragment data based on the expected lifetime of each fragment data in each distribution vehicle 2.

The expected lifetime can be said to be a period of time from when the fragment data is held in the distribution vehicle 2 to when the fragment data is deleted from the storage. The distribution control unit 12 estimates that fragment data #X will be deleted from the storage at a timing, in a predetermined period of time in the future, when the estimated value of the remaining storage capacity will, for the first time, fall below a total value of sizes of the fragment data #X and all the pieces of the fragment data with deletion timings later than the fragment data #X.

A description will be given taking as an example a case where the estimation result for transition in the remaining storage capacity in the distribution vehicle 2 is as illustrated in FIG. 5. There are fragment data P10, P20, and P30. With respect to the fragment data P10, the number indicating deletion timing is 1, and the data size is K1. With respect to the fragment data P20, the number indicating deletion timing is 2, and the data size is K2. With respect to the fragment data P30, the number indicating deletion timing is 3, and the data size is K3. In the example illustrated in FIG. 5, the deletion timing is earlier, the smaller the number.

According to the estimation result for transition in the remaining storage capacity illustrated in FIG. 5, the timing when the remaining storage capacity in the distribution vehicle 2 falls, for the first time, below a total value K1+K2+K3 of the sizes of the fragment data P10 and the fragment data P20 and P30 with later deletion timings than the fragment data P10 is a time T10. Accordingly, the expected lifetime of the fragment data P10 is T10. According to the estimation result for transition in the remaining storage capacity illustrated in FIG. 5, the timing when the remaining storage capacity in the distribution vehicle 2 falls, for the first time, below a total value K2+K3 of the sizes of the fragment data P20 and the fragment data P30 with a later deletion timing than the fragment data P20 is a time T20. Accordingly, the expected lifetime of the fragment data P20 is T20. According to the estimation result for transition in the remaining storage capacity illustrated in FIG. 5, the timing when the remaining storage capacity in the distribution vehicle 2 falls, for the first time, below the size K3 of the fragment data P30 is a time T30. Accordingly, the expected lifetime of the fragment data P30 is T30. It can thus be seen that the expected lifetime is shorter for the fragment data with an earlier deletion timing.

Next, a fragment data transmission destination determination process based on the expected lifetime will be described. The distribution control unit 12 determines the distribution vehicles 2 that are to be the transmission destinations of fragment data #X in such a way that a total value of the expected lifetimes at the distribution vehicles 2 as the transmission destinations of the fragment data #X becomes equal to or greater than a predetermined threshold. For example, in the case where the distribution vehicles 2 as the transmission destinations of the fragment data #X are given as V1, V2, . . . , Vm, the expected lifetime of the fragment data #X at each distribution vehicle 2 will be expressed as E1, E2, . . . , Em, respectively. The distribution control unit 12 determines m distribution vehicles 2 as the transmission destinations in such a way that a total value E=E1+E2+ . . . +Em of the expected lifetimes of the fragment data at the distribution vehicles 2 as the transmission destinations becomes equal to or greater than a threshold Eth. In the case where the total value of the expected lifetimes is smaller than the threshold Eth, the distribution control unit 12 increases the number m of the distribution vehicles 2 as the transmission destinations. The distribution vehicles 2 included in the m vehicles may be randomly selected, or may be selected in such a way that a density of the distribution vehicles 2 as the transmission destinations of the fragment data #X becomes uniform in an area.

It can thus be understood that, in the case where the transmission destinations of fragment data are to be determined based on the expected lifetime, the shorter the expected lifetime of the fragment data, the greater the number of distribution vehicles 2 that are determined as the transmission destinations of the fragment data. The earlier the deletion timing of fragment data, the shorter the expected lifetime of the fragment data. Accordingly, in the case where the transmission destinations of fragment data are to be determined based on the expected lifetime, the earlier the deletion timing of the fragment data, the greater the number of distribution vehicles 2 to which the fragment data is transmitted. Furthermore, the distribution vehicles 2 as the transmission destinations are determined for any fragment data in such a way that the total value E of the expected lifetimes at the distribution vehicles 2 as the transmission destinations is equal to or greater than the threshold Eth. Accordingly, opportunity for distribution in a predetermined period of time becomes approximately the similar among pieces of fragment data regardless of the deletion timings.

Additionally, the distribution server 1 may determine the transmission destinations of fragment data by using a constant that is set in advance as a time length when each fragment data is held in the distribution vehicle 2, without acquiring the expected lifetime. The constant of the time length when fragment data is held in the distribution vehicle 2 may take a uniform value irrespective of fragment data and distribution vehicle 2, or may take different values depending on type or data size of the fragment data or specifications of the distribution vehicle 2, for example.

In the fragment data transmission destination determination process based on the expected lifetime, the distribution control unit 12 may change the threshold Eth for the total value of expected lifetimes of fragment data at the distribution vehicles 2 as the transmission destinations according to a degree of priority of content that is to be distributed. For example, it is assumed that a vehicle of vehicle type A has a relatively higher market share than a vehicle of vehicle type B. In this case, a degree of priority of software update data for the vehicle of vehicle type A may be set higher than that of software update data for the vehicle of vehicle type B, and the threshold Eth may be set higher for the fragment data of the software update data for the vehicle of vehicle type A than for vehicle type B. The software update data for the vehicle of vehicle type A is thus transmitted to a greater number of distribution vehicles 2, and opportunity for distribution by inter-vehicle communication can be reliably guaranteed, and a delay time in the distribution can be reduced. By contrast, with respect to the vehicle of vehicle type B with a lower degree of priority, pieces of fragment data for acquiring the software update data are possibly not acquired by inter-vehicle communication within a specific period of time, and unacquired fragment data may have to be directly downloaded from the distribution server 1 by cellular communication or the like. However, the number of vehicles of vehicle type B is smaller than vehicle type A, and influence on the communication cost is relatively small.

### (Flow of Processes)

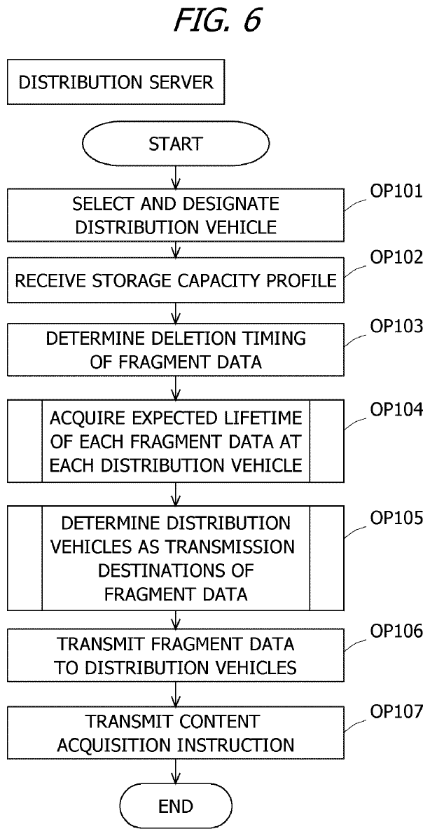

FIG. 6 is an example of a flowchart of a process by the distribution server 1. The process illustrated in FIG. 6 is started when there is occurrence of an event indicating content distribution start. An event indicating content distribution start may be input of an operation instructing content distribution from an administrator of the content distribution system 100, or that a scheduled time of content distribution start is reached, for example. However, the event indicating content distribution start is not limited to such examples. A main performer of the processes illustrated in FIG. 6 is the processor 101 of the distribution server 1, but a functional element will be described as the main performer for the sake of convenience. The same applies to flowcharts subsequent to FIG. 6.

In OP101, the distribution control unit 12 selects a plurality of distribution vehicles 2, and transmits the notification of designation as distribution vehicle to the distribution vehicles 2 that are selected. In OP102, the distribution control unit 12 receives the storage capacity profile from each distribution vehicle 2. In OP103, the distribution control unit 12 acquires, from the data block generation unit 11, pieces of fragment data generated from content to be distributed, and determines the deletion timings of each of the pieces of the fragment data. In OP104, the distribution control unit 12 acquires the expected lifetime at each distribution vehicle 2 in relation to each of the pieces of fragment data (see FIG. 5). In OP105, the distribution control unit 12 determines the distribution vehicles 2 that are to be the transmission destinations in relation to each of the pieces of fragment data in such a way that the fragment data is transmitted to a greater number of distribution vehicles 2, the earlier the deletion timing (see FIG. 5). In OP106, the distribution control unit 12 transmits each of the pieces of fragment data to the distribution vehicles 2 as the transmission destinations that are determined in OP105. In OP107, the distribution control unit 12 transmits the content acquisition instruction to the reception vehicle 3. The process illustrated in FIG. 6 is then ended.

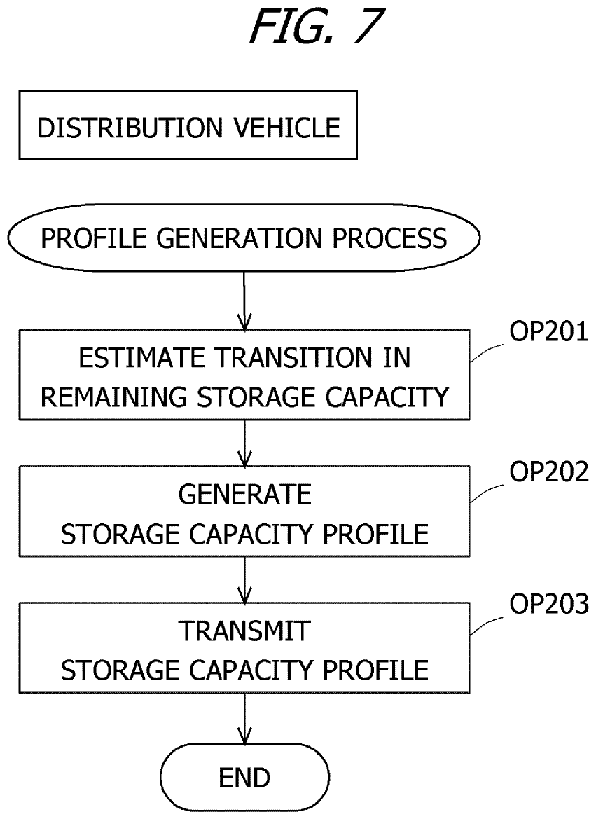

FIG. 7 is an example of a flowchart of a storage capacity profile generation process by the distribution vehicle 2. In the first embodiment, the process illustrated in FIG. 7 is started when the distribution vehicle 2 receives the notification of designation as distribution vehicle from the distribution server 1. In the case where notification of selection as the distribution vehicle is performed by push-transmission of fragment data, the process illustrated in FIG. 7 is started when the fragment data is received, for example.

In OP201, the profile generation unit 21 analyzes the history of the remaining storage capacity, and performs estimation regarding transition in the remaining storage capacity. In OP202, the profile generation unit 21 generates the storage capacity profile including the estimation result for transition in the remaining storage capacity. In OP203, the profile generation unit 21 transmits the storage capacity profile to the distribution server 1. The process illustrated in FIG. 7 is then ended.

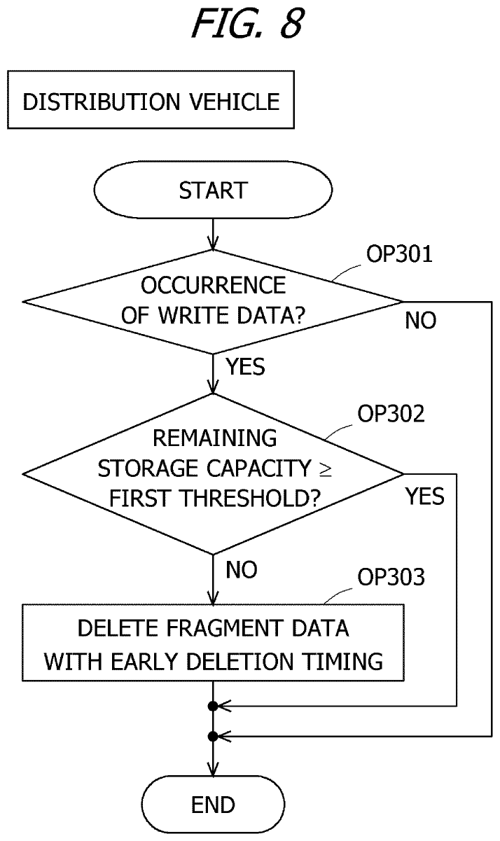

FIG. 8 is an example of a flowchart of a content management process by the distribution vehicle 2. The process illustrated in FIG. 8 is repeatedly performed every predetermined period during operation of the in-vehicle apparatus 20. In OP301, the content management unit 24 determines whether there is occurrence of write data from an application program that is installed in the in-vehicle apparatus 20. In the case where there is occurrence of write data from the application program (OP301: YES), the process proceeds to OP302. In the case where there is no occurrence of write data from the application program (OP301: NO), the process illustrated in FIG. 8 is ended.

In OP302, the content management unit 24 determines whether the remaining storage capacity is equal to or greater than the first threshold. In the case where the remaining storage capacity is equal to or greater than the first threshold (OP302: YES), the process illustrated in FIG. 8 is ended. In the case where the remaining storage capacity is smaller than the first threshold (OP302: NO), the process proceeds to OP303. In OP303, the content management unit 24 deletes the fragment data with the earliest deletion timing from the storage. The content management unit 24 may keep deleting the fragment data with the earliest deletion timing from the storage until the remaining storage capacity becomes equal to or greater than the second threshold. The process illustrated in FIG. 8 is then ended.

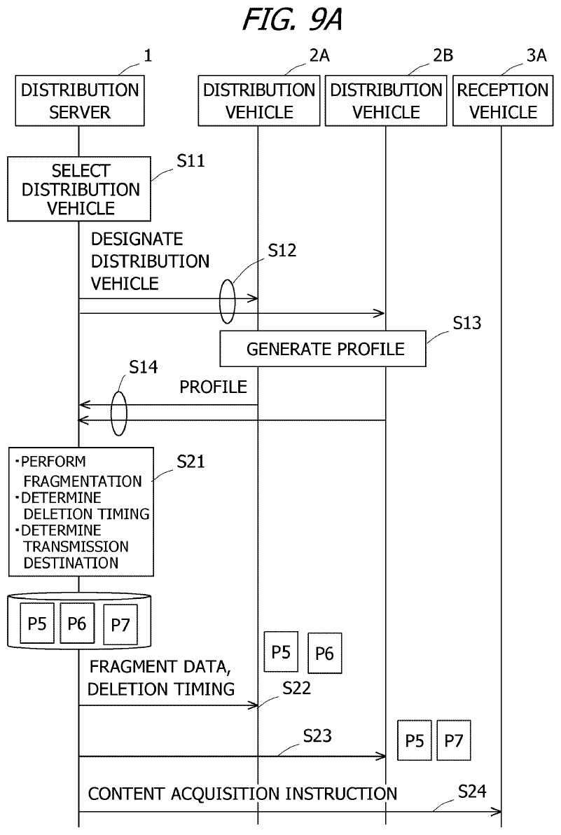

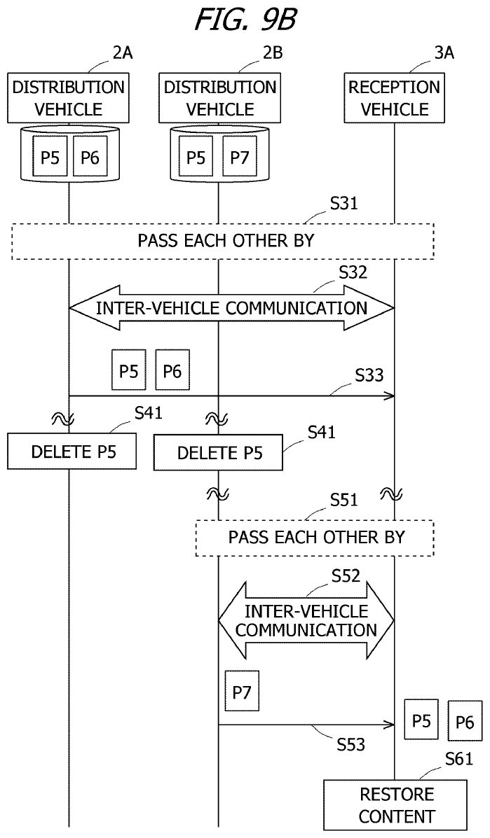

FIGS. 9A and 9B are diagrams illustrating an example of a sequence of a content distribution process of the content distribution system 100. Additionally, in FIGS. 9A and 9B, the distribution vehicle 2A, the distribution vehicle 2B, and a reception vehicle 3A are illustrated as representatives of the distribution vehicle 2 and the reception vehicle 3.

In S11, the distribution server 1 selects the distribution vehicle 2A and the distribution vehicle 2B as the distribution vehicles from among vehicles that are managed by the content distribution system 100. In S12, the distribution server 1 transmits the notification of designation as distribution vehicle to the distribution vehicle 2A and the distribution vehicle 2B (FIG. 6, OP101). In S13, the distribution vehicle 2A and the distribution vehicle 2B each receive the notification of designation as distribution vehicle from the distribution server 1, and generate the storage capacity profile (FIG. 7, OP201, OP202). In S14, the distribution vehicle 2A and the distribution vehicle 2B each transmit the storage capacity profile to the distribution server 1 (FIG. 7, OP203).

In S21, the distribution server 1 generates pieces of fragment data from the content to be distributed, determines the deletion timings (FIG. 6, OP103), acquires, in relation to each of the pieces of fragment data, the expected lifetime at the distribution vehicle 2A and the distribution vehicle 2B based on the deletion timing and the data size (FIG. 6, OP104), and determines the transmission destinations based on the expected lifetime (FIG. 6, OP105). In the example illustrated in FIGS. 9A and 9B, the distribution content is assumed to be divided into fragment data P5, P6, and P7. Furthermore, the deletion timing is assumed to be one of two stages, “early” and “late”. It is assumed that the deletion timing of the fragment data P5 is determined to be “early”. It is assumed that the deletion timings of the fragment data P6 and P7 are determined to be “late”. It is assumed that the distribution server 1 determines the distribution vehicle 2A and the distribution vehicle 2B as the transmission destinations of the fragment data P5, the distribution vehicle 2A as the transmission destination of the fragment data P6, and the distribution vehicle 2B as the transmission destination of the fragment data P7.

In S22, the distribution server 1 transmits the fragment data P5 and P6 to the distribution vehicle 2A together with respective deletion timings (FIG. 6, OP106). In S23, the distribution server 1 transmits the fragment data P5 and P7 to the distribution vehicle 2B together with respective deletion timings (FIG. 6, OP106). The distribution vehicle 2A and the distribution vehicle 2B each store the pieces of fragment data received from the distribution server 1 in the storage. In S24, the distribution server 1 transmits the content acquisition instruction to the reception vehicle 3A (FIG. 6, OP107). The content acquisition instruction specifies the fragment data P5, P6, and P7 as the pieces of fragment data that are acquisition targets of the reception vehicle 3A.

In S31 in FIG. 9B, the distribution vehicle 2A and the reception vehicle 3A pass each other by on a road. In S32, the distribution vehicle 2A and the reception vehicle 3A establish inter-vehicle communication with each other. At this time, the reception vehicle 3A requests and acquires a list of fragment data held by the distribution vehicle 2A, and transmits an acquisition request to the distribution vehicle 2A in relation to fragment data, in the list, that is specified by the content acquisition instruction received from the distribution server 1 in S24 and that is not yet obtained. The list of fragment data held by the distribution vehicle 2A includes the fragment data P5 and P6. Furthermore, the fragment data P5 and P6 are acquisition targets of the reception vehicle 3A and are not yet acquired by the reception vehicle 3A, and thus, the reception vehicle 3A transmits an acquisition request regarding the fragment data P5 and P6 to the distribution vehicle 2A. In S33, the distribution vehicle 2A transmits the requested fragment data P5 and P6 to the reception vehicle 3A by inter-vehicle communication. The reception vehicle 3A stores the fragment data P5 and P6 that are received in the auxiliary storage device 203.

In S41, time passes, and the remaining storage capacity at each of the distribution vehicle 2A and the distribution vehicle 2B falls below the first threshold, and the fragment data P5 with an early deletion timing is deleted from the storages. Additionally, in FIG. 9B, for the sake of simplicity, deletion of the fragment data P5 from the distribution vehicle 2A and deletion of the fragment data P5 from the distribution vehicle 2B are collectively described, but such deletion occurs at independent timings.

In S51, time further passes, and the distribution vehicle 2B and the reception vehicle 3A pass each other by on a road. In S52, the distribution vehicle 2B and the reception vehicle 3A establish inter-vehicle communication with each other. At this time, the reception vehicle 3A acquires the list of fragment data held by the distribution vehicle 2B where the fragment data P7 is included, and transmits an acquisition request to the distribution vehicle 2B in relation to the fragment data P7, in the list, that is fragment data that is specified by the content acquisition instruction received from the distribution server 1 in S24 and that is not yet obtained. In S53, the distribution vehicle 2B transmits the requested fragment data P7 to the reception vehicle 3A by inter-vehicle communication. The reception vehicle 3A stores the fragment data P7 that is received in the auxiliary storage device 203.

In S61, because the fragment data P5, P6, and P7 to restore the content are obtained, the reception vehicle 3A restores and acquires the original content from the fragment data P5, P6, and P7. Additionally, the sequence of the process illustrated in FIGS. 9A and 9B is merely an example, and may be changed as appropriate according to the aspect of the embodiment.

### <Operations and Effects of First Embodiment>

In the first embodiment, in the content distribution system that uses inter-vehicle communication, fragment data, the deletion timing of which in a case where there is not sufficient remaining storage capacity is early, is transmitted to a greater number of distribution vehicles 2. Accordingly, opportunity for distribution of fragment data with an early deletion timing is increased, and the fragment data is more likely to be distributed to the reception vehicle 3 before being deleted. For example, in the example illustrated in FIGS. 9A and 9B, the fragment data P5 with an early deletion timing is transmitted to and held by both the distribution vehicle 2A and the distribution vehicle 2B. Accordingly, the reception vehicle 3A may acquire the fragment data P5 from the distribution vehicle 2A or the distribution vehicle 2B by inter-vehicle communication. In FIG. 9B, the reception vehicle 3A receives the fragment data P5 from the distribution vehicle 2A, but if the reception vehicle 3A passes by the distribution vehicle 2B first, the reception vehicle 3A may acquire the fragment data P5 from the distribution vehicle 2B. Furthermore, in the example illustrated in FIG. 9B, even in the case where the fragment data P5 is deleted from both the distribution vehicle 2A and the distribution vehicle 2B due to insufficient remaining storage capacity, the fragment data P5 is already acquired by the reception vehicle 3A beforehand. Accordingly, the reception vehicle 3A may reliably acquire the fragment data P5 from the distribution vehicle 2 by inter-vehicle communication, and time to acquire the content may be reduced.

Furthermore, with the distribution vehicle 2, when the remaining storage capacity becomes insufficient, fragment data with an early deletion timing may be deleted from the storage or may be overwritten by data of another application. Accordingly, fragment data may be prevented from occupying the storage in the distribution vehicle 2 and from affecting operation of other application programs. Moreover, because fragment data is deleted according to the deletion timing when the remaining storage capacity becomes insufficient, a memory area where fragment data with an early deletion timing is stored may be regarded as the short-term cache and a memory area where fragment data with a late deletion timing is stored may be regarded as the long-term cache, thereby the storage may be dynamically used as like a short-term cache or a long-term cache.

### <Variation of First Embodiment>

In the first embodiment, the distribution server 1 determines the distribution vehicles 2 that are to be the transmission destinations of fragment data in such a way that the total value of expected lifetimes of the fragment data at the distribution vehicles 2 as the transmission destinations becomes equal to or greater than a predetermined threshold. Instead, the distribution control unit 12 of the distribution server 1 may, depending on whether the expected lifetime in a case where fragment data is transmitted to a certain distribution vehicle 2 is equal to or greater than a threshold, determine to transmit the fragment data to the distribution vehicle 2 in question and redundantly to another distribution vehicle 2.

More specifically, in the case where the expected lifetime in a case where fragment data is transmitted to a certain distribution vehicle 2 is equal to or greater than a threshold, the distribution control unit 12 determines to transmit the fragment data to the distribution vehicle 2 in question, and to not transmit the fragment data to another distribution vehicle 2 in a redundant manner. In the case where the expected lifetime in a case where the fragment data is transmitted to a certain distribution vehicle 2 is smaller than the threshold, the distribution control unit 12 determines to transmit the fragment data to the distribution vehicle 2 in question, and to further transmit the fragment data to another distribution vehicle 2 in a redundant manner. As the expected lifetime of the fragment data used in the determination, a longest expected lifetime, a shortest expected lifetime, or a mean value or a median value of the expected lifetimes, among the expected lifetimes of the fragment data in a plurality of distribution vehicles 2 may be used. Furthermore, in the case of redundantly transmitting the fragment data, a predetermined number of distribution vehicles 2 may be determined as the transmission destinations, or a number of distribution vehicles 2 may be determined as the transmission destinations, where the number changes according to the value of the expected lifetime used in the determination described above.

In the case where it is determined whether to transmit the fragment data to a plurality of distribution vehicles 2 in a redundant manner or not, according to whether the expected lifetime of the fragment data is equal to or greater than a threshold or not, the process is simplified, and a processing load on the distribution server 1 may be reduced. Moreover, the number of distribution vehicles 2 as the transmission destinations may be determined based on to which range among a plurality of ranges defined by a plurality of thresholds the expected lifetime of the fragment data belongs. For example, in a case where threshold A<threshold B is true, the number of transmission destinations of fragment data may be set for each range in such a way that the number is increased in an ascending order of a case of smaller than threshold A>a case of equal to or greater than threshold A and smaller than threshold B>a case of equal to or greater than threshold B.

Moreover, instead of transmitting the deletion timing to the distribution vehicle 2 together with the fragment data, the distribution server 1 may transmit the expected lifetime of fragment data at the distribution vehicle 2 together with the fragment data. This is because the earlier the deletion timing, the shorter the expected lifetime.

### Second Embodiment

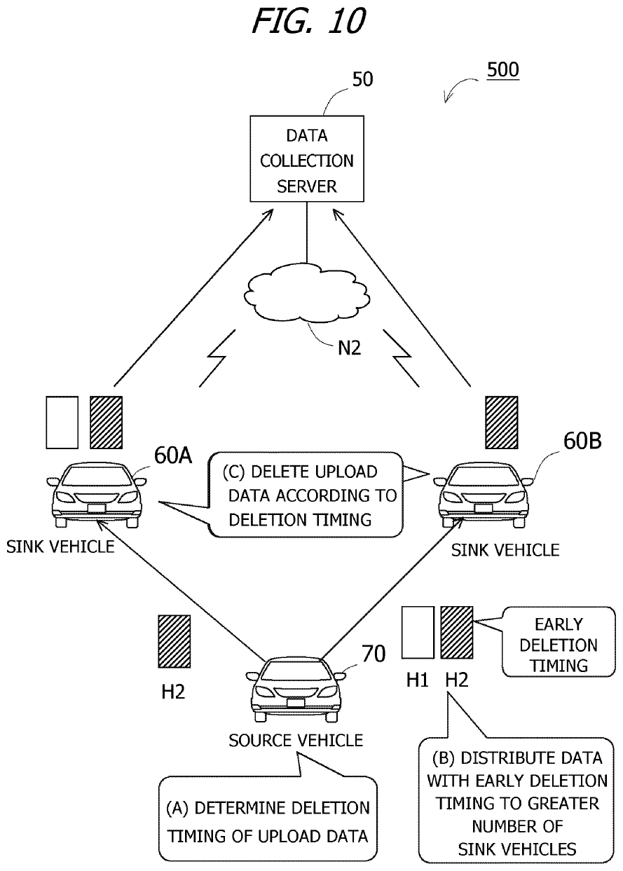

FIG. 10 is a diagram illustrating an example of a system configuration of a data collection system 500 according to a second embodiment. The data collection system 500 is a system that causes a sink vehicle to collect data that is generated by a source vehicle by inter-vehicle communication. An example of data that is generated by the source vehicle is sensor data. In the following, data that is generated by a source vehicle 70 and that is a collection target in the data collection system 500 will be referred to as upload data.

The data collection system 500 includes the source vehicle 70 that generates the upload data, a sink vehicle 60 that acquires the upload data from the source vehicle 70 by inter-vehicle communication, and a data collection server 50 that collects the upload data generated by the source vehicle 70 from the sink vehicle 60. Additionally, a plurality of sink vehicles 60 and a plurality of source vehicles 70 are included in the data collection system 500, and FIG. 10 illustrates a sink vehicle 60A, a sink vehicle 60B, and the source vehicle 70 as representatives. When not distinguishing between each other, simple terms “sink vehicle(s) 60” and “source vehicle(s) 70” will be used. In the following, actual main performers of communication by the sink vehicle 60 and the source vehicle 70 are in-vehicle apparatuses, but for the sake of convenience, the sink vehicle 60 or the source vehicle 70 will be described to be the main performer.

The data collection server 50, the sink vehicle 60, and the source vehicle 70 are connected to a network N2, and are capable of communicating with one another via the network N2. For example, the network N2 is a public network such as the Internet. The sink vehicle 60 and the source vehicle 70 are capable of connecting to the network N2 via a cellular network or a wireless LAN as an access network.

The data collection server 50 collects and analyzes the upload data generated by the source vehicle 70, and performs grasping of a road traffic state, generation of a digital map, and learning of a machine learning model, for example. The source vehicle 70 temporarily stores the generated upload data in a storage in the in-vehicle apparatus, and transmits the stored upload data by inter-vehicle communication when passing by the sink vehicle 60.

The sink vehicle 60 temporarily stores the upload data received from at least one source vehicle 70 by inter-vehicle communication in the in-vehicle apparatus, and collectively uploads the upload data that is temporarily stored to the data collection server 50 at a predetermined timing by WiFi communication or cellular communication. A timing when the sink vehicle 60 collectively uploads the upload data to the data collection server 50 is when the sink vehicle 60 connects to a WiFi access point during parking, for example. Additionally, the sink vehicle 60 may operate also as the source vehicle 70. When the sink vehicle 60 collects the upload data from the source vehicle 70 by inter-vehicle communication and collectively uploads the upload data to the data collection server 50, a communication cost of data collection may be reduced. In the case where the sink vehicle 60 uploads the upload data by WiFi communication, the communication cost of data collection may be further reduced. In the second embodiment, inter-vehicle communication may be any of inter-vehicle wireless LAN communication, DSRC, or 5G sidelink communication, for example.

First, a flow of data collection by inter-vehicle communication will be described. The data collection server 50 selects a plurality of sink vehicles 60 and a plurality of source vehicles 70 from among vehicles that are managed by the data collection system 500, according to a predetermined policy or the like. The data collection server 50 transmits a notification of designation as sink vehicle to the selected sink vehicles 60 by WiFi communication or cellular communication, for example. The data collection server 50 transmits a data collection instruction to the selected source vehicles 70. The data collection instruction includes a type of upload data generated by the source vehicle 70, an acquisition time, an acquisition frequency, and a list of sink vehicles, for example.

The source vehicle 70 generates and collects upload data according to the data collection instruction, and transmits the upload data by inter-vehicle communication to a sink vehicle 60 that is specified, when passing by the sink vehicle 60. The sink vehicle 60 temporarily saves the upload data received from the source vehicle 70 in a storage in the in-vehicle apparatus, and performs proxy transmission of the upload data that is temporarily saved to the data collection server 50 by WiFi communication at a next timing of connecting to the WiFi access point.

In the case where the remaining storage capacity in the sink vehicle 60 is not enough, even if the sink vehicle 60 passes by the source vehicle 70 on a road and the upload data is received by inter-vehicle communication, the received upload data is overwritten by data of another application program, for example, and is not kept in the cache. In the second embodiment, based on the first embodiment where the fragment data with an earlier deletion timing is transmitted to a greater number of distribution vehicles 2, the source vehicle 70 transmits the upload data with an earlier deletion timing to a greater number of sink vehicles 60.

More specific details are given below. (A) The source vehicle 70 determines the deletion timing of upload data for when the remaining storage capacity in the sink vehicle 60 becomes insufficient. (B) The source vehicle 70 performs transmission in such a way that upload data with an earlier deletion timing is transmitted to a greater number of sink vehicles 60. At this time, the source vehicle 70 transmits the deletion timing to the sink vehicle 60 together with the upload data. In the second embodiment, the source vehicle 70 receives the storage capacity profile from the sink vehicle 60, predicts transition in the remaining storage capacity in the sink vehicle 60 based on the storage capacity profile of the sink vehicle 60, and determines whether to continue transmission of the upload data to the sink vehicle 60, based on an expected lifetime of the upload data in the sink vehicle 60.

For example, in FIG. 10, the source vehicle 70 holds upload data H1 and H2. The deletion timing of the upload data H2 is earlier than that of the upload data H1, and thus, the upload data H2 is transmitted to the sink vehicle 60A and the sink vehicle 60B. Even if the upload data H2 is deleted from one of the sink vehicle 60A or the sink vehicle 60B before transmission to the data collection server 50, the upload data H2 is possibly transmitted to the data collection server 50 from the other vehicle. Accordingly, the possibility of upload of the upload data H2 to the data collection server 50 may be increased. Furthermore, even if the data collection server 50 redundantly receives the upload data H2 from both the sink vehicle 60A and the sink vehicle 60B, redundant data may be deleted, for example, and processing by the data collection server 50 is not particularly affected.

(C) At the sink vehicle 60, when the remaining storage capacity becomes insufficient, deletion is performed from upload data with an early deletion timing. Accordingly, exertion of pressure on the storage capacity in the sink vehicle 60 by the upload data may be prevented. Upload data with a late deletion timing is held by the sink vehicle 60 for a longer period of time. Accordingly, also in the second embodiment, the storage in the sink vehicle 60 may be dynamically used as a short-term cache and a long-term cache without securing a short-term cache and a long-term cache in the storage in the sink vehicle 60.

The upload data is an example of “data block”. The sink vehicle 60 is an example of “first mobile body”. The data collection server 50 is an example of “another apparatus”. Inter-vehicle communication is an example of “inter-device communication”. The in-vehicle apparatus mounted in the source vehicle 70 is an example of “information processing apparatus”.

A hardware configuration of the data collection server 50 is the similar as the hardware configuration of the distribution server 1 according to the first embodiment. That is, like the hardware configuration of the distribution server 1 illustrated in FIG. 2, for example, the data collection server 50 includes a processor, a memory, an auxiliary storage device, and a communication unit. Hardware configurations of the sink vehicle 60 and the source vehicle 70 are the similar as those of the distribution vehicle 2 and the reception vehicle 3 according to the first embodiment. That is, the sink vehicle 60 and the source vehicle 70 include an in-vehicle apparatus. Like the in-vehicle apparatus 20 illustrated in FIG. 2, the in-vehicle apparatus includes a processor, a memory, an auxiliary storage device, a wireless communication unit, and an inter-vehicle communication unit.

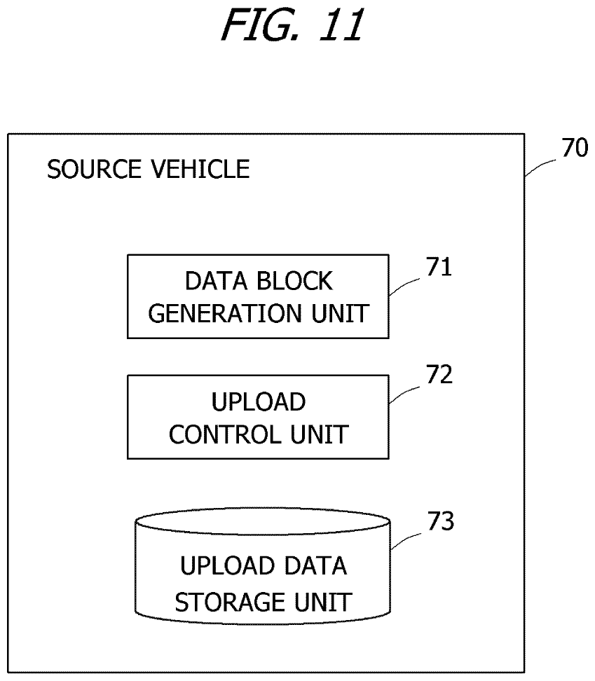

FIG. 11 is a diagram illustrating an example of a functional configuration of the source vehicle 70. As functional components, the source vehicle 70 includes a data block generation unit 71, an upload control unit 72, and an upload data storage unit 73. The data block generation unit 71, the upload control unit 72, and the upload data storage unit 73 are functional elements that are implemented by execution of predetermined programs by the processor of the source vehicle 70, for example. However, each of the data block generation unit 71, the upload control unit 72, and the upload data storage unit 73 may instead be implemented by a hardware element such as an FPGA.

The upload data storage unit 73 holds the upload data. The upload data storage unit 73 is created in a memory area in the auxiliary storage device of the source vehicle 70. When the data collection instruction is received from the data collection server 50, the data block generation unit 71 starts generation of the upload data. For example, the data block generation unit 71 acquires a detection value from an in-vehicle sensor, generates upload data, and stores the upload data in the upload data storage unit 73. Additionally, sensor data that is assumed as the upload data in the second embodiment has a small data size, and is uploaded without being divided. In the case where the size of the upload data is great, the data block generation unit 71 may divide the upload data and generate pieces of fragment data.

The upload control unit 72 performs determination of the deletion timing of upload data for when the remaining storage capacity in the sink vehicle 60 becomes insufficient ((A) in FIG. 10), and determination of continuance or stop of transmission of upload data to the sink vehicle 60 ((B) in FIG. 10). The upload control unit 72 determines the deletion timing of upload data based on the type of sensor data, for example. As in the first embodiment, the deletion timing may be sorted into one of two stages, namely, early or late, or may be sorted into one of three or more levels, or may be indicated by a degree of priority of the upload data.

The upload control unit 72 receives the storage capacity profile from the sink vehicle 60 after inter-vehicle communication with the sink vehicle 60 is established. The storage capacity profile is the similar as that in the first embodiment. Based on the storage capacity profile of the sink vehicle 60 and the deletion timing and the data size of upload data, the upload control unit 72 acquires the expected lifetime at the sink vehicle 60 in relation to each upload data that is held in the upload data storage unit 73 and end of transmission of which is not determined. The method for acquiring the expected lifetime is the similar as that in the first embodiment.

As in the first embodiment, the upload control unit 72 determines, in relation to each upload data, whether to continue transmission of the upload data to the sink vehicle 60, based on whether the total value of expected lifetimes at the sink vehicles 60 as the transmission destinations including the transmission destinations of past transmission is equal to or greater than the threshold Eth. More specifically, in the case where the total value of expected lifetimes is smaller than the threshold Eth, the upload control unit 72 determines to continue transmitting the upload data to the sink vehicle 60. In the case where the total value of expected lifetimes is equal to or greater than the threshold Eth, the upload control unit 72 determines to stop transmission of the upload data to the sink vehicle 60. The earlier the deletion timing, the shorter the expected lifetime and thus, the earlier the deletion timing, the greater the number of sink vehicles 60 to which the upload data is transmitted.

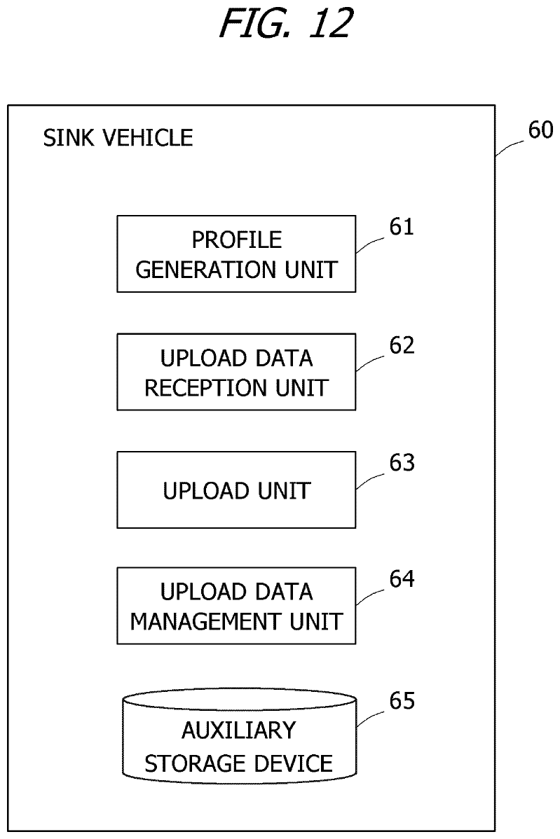

FIG. 12 is a diagram illustrating an example of a functional configuration of the sink vehicle 60. As functional components, the sink vehicle 60 includes a profile generation unit 61, an upload data reception unit 62, an upload unit 63, and an upload data management unit 64. The profile generation unit 61, the upload data reception unit 62, the upload unit 63, and the upload data management unit 64 are functional elements that are implemented by execution of predetermined programs by the processor of the sink vehicle 60, for example. However, each of the profile generation unit 61, the upload data reception unit 62, the upload unit 63, and the upload data management unit 64 may instead be implemented by a hardware element such as an FPGA.

The profile generation unit 61, the upload data reception unit 62, the upload unit 63, and the upload data management unit 64 are activated when the notification of designation as sink vehicle is received from the data collection server 50. When inter-vehicle communication with the source vehicle 70 is established, the profile generation unit 61 generates the storage capacity profile, and transmits the storage capacity profile to the source vehicle 70 by inter-vehicle communication. The method for generating the storage capacity profile is the similar as that in the first embodiment. A process by the profile generation unit 61 is the similar as the profile generation process illustrated in FIG. 7, for example.

The upload data reception unit 62 receives upload data from the source vehicle 70 by inter-vehicle communication, and stores the upload data in an auxiliary storage device 65. When a predetermined event occurs, the upload unit 63 transmits the upload data to the distribution server 1 by WiFi communication or cellular communication, for example. The predetermined event is that the sink vehicle 60 is connected to a WiFi access point in a parked state, that a predetermined time is reached, or that a total size of upload data in the auxiliary storage device 65 reaches or exceeds a predetermined value, for example. The upload unit 63 may delete the upload data uploaded to the distribution server 1 from the auxiliary storage device 65.

The upload data management unit 64 manages the upload data that is held in the auxiliary storage device 65. More specifically, when the remaining storage capacity falls below a third threshold, the upload data management unit 64 deletes, from the auxiliary storage device 65, the upload data with the earliest deletion timing among pieces of the upload data held in the auxiliary storage device 65. The upload data management unit 64 may keep deleting the upload data with the earliest deletion timing from the auxiliary storage device 65 until the remaining storage capacity reaches or exceeds a fourth threshold. The fourth threshold is a value that is equal to or greater than the third threshold. Deletion of the upload data from the auxiliary storage device 65 by the upload data management unit 64 is performed in the similar manner as deletion, in the first embodiment, of the fragment data from the auxiliary storage device 203 by the content management unit 24 (for example, FIG. 8). Additionally, the functional configuration of the sink vehicle 60 is not limited to the example illustrated in FIG. 12.

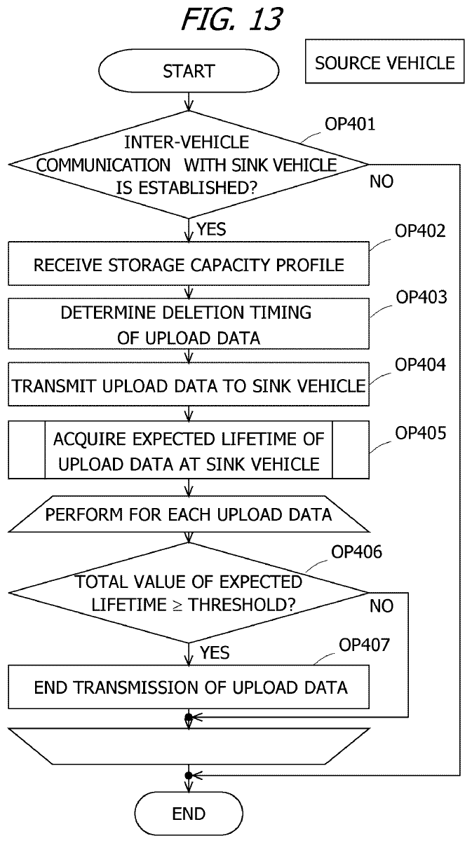

FIG. 13 is an example of a flowchart of an upload data transmission process by the source vehicle 70. The process illustrated in FIG. 13 is started when the data collection instruction is received from the distribution server 1, and is repeated every predetermined period of time, for example.

In OP401, the upload control unit 72 determines whether inter-vehicle communication with the sink vehicle 60 is established or not. In the case where inter-vehicle communication with the sink vehicle 60 is established (OP401: YES), the process proceeds to OP402. In the case where inter-vehicle communication with the sink vehicle 60 is not established (OP401: NO), the process illustrated in FIG. 13 is ended.

In OP402, the upload control unit 72 receives the storage capacity profile from the sink vehicle 60 by inter-vehicle communication. In OP403, the upload control unit 72 determines the deletion timing of the upload data in the upload data storage unit 73. In OP404, the upload control unit 72 transmits, to the sink vehicle 60 by inter-vehicle communication, the upload data, transmission of which is not ended, among pieces of the upload data in the upload data storage unit 73. In OP405, the upload control unit 72 acquires the expected lifetime at the sink vehicle 60 in relation to each upload data in the upload data storage unit 73.

Processes in OP406 and OP407 are performed for each upload data transmitted in OP404 (upload data for which end of transmission is not determined). In OP406, the upload control unit 72 determines, in relation to target upload data, whether the total value of expected lifetimes at the sink vehicles 60 as transmission destinations to which the target upload data is already transmitted is equal to or greater than the threshold Eth or not. In the case where the total value of expected lifetimes is equal to or greater than the threshold Eth (OP406: YES), the process proceeds to OP407. In OP407, the upload control unit 72 determines end of transmission of the target upload data. In the case where the total value of expected lifetimes is smaller than the threshold Eth (OP406: NO), the process in OP406 is performed for the next upload data, or in the case where the processes in OP406 and OP407 are ended for all the upload data transmitted in OP404, the process illustrated in FIG. 13 is ended.

In the processes in OP406 and OP407, whether transmission of the target upload data to the sink vehicle 60 is to be continued or ended is determined. Accordingly, upload data with a short expected lifetime, or in other words, an early deletion timing, is transmitted to a greater number of sink vehicles 60.

Additionally, the process by the source vehicle 70 illustrated in FIG. 13 is merely an example, and can be changed as appropriate according to the aspect of the embodiment. For example, the deletion timing of upload data may be determined when the upload data is acquired and stored in the upload data storage unit 73, before inter-vehicle communication with the sink vehicle 60 is established.

Furthermore, in the example illustrated in FIG. 13, upload data is transmitted to the sink vehicle 60 by inter-vehicle communication, and then, whether to continue or stop transmission of each upload data to the sink vehicle 60 is determined (OP406, OP407). However, the upload control unit 72 may determine whether to transmit upload data to the sink vehicle 60 with which inter-vehicle communication is currently established, based on the total value of expected lifetimes at the sink vehicles 60 as transmission destinations to which transmission is already performed, as in OP406.

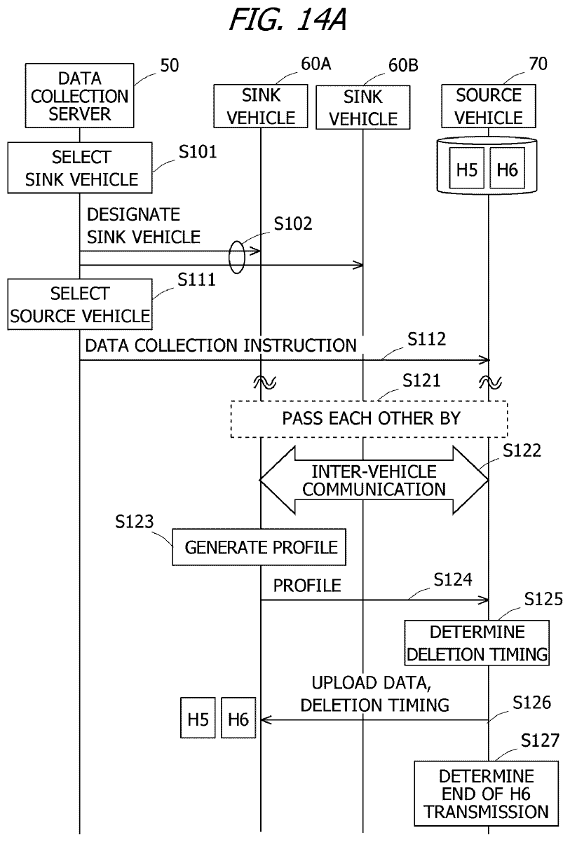

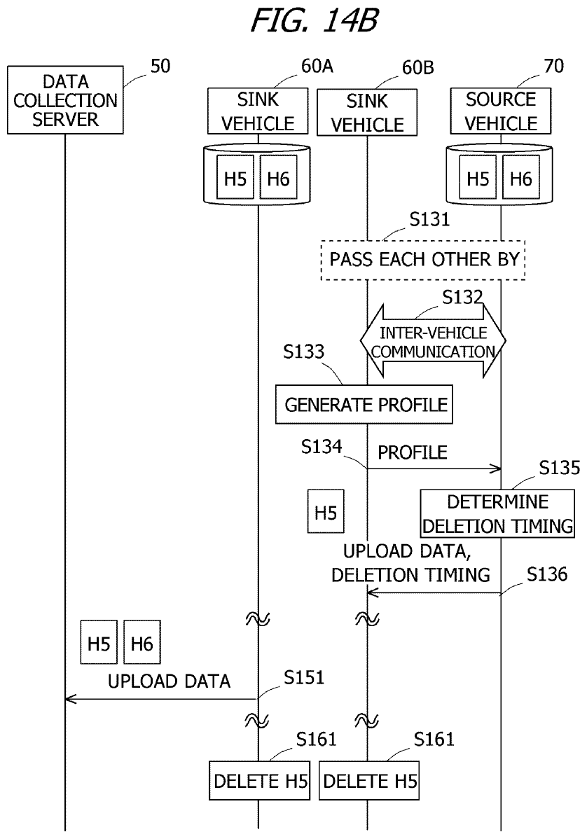

FIGS. 14A and 14B are diagrams illustrating an example of a sequence of an upload data collection process of the data collection system 500. Additionally, in FIGS. 14A and 14B, the sink vehicle 60A, the sink vehicle 60B, and a source vehicle 70A are illustrated as representatives of the sink vehicle 60 and the source vehicle 70.

In S101, the data collection server 50 selects, as the sink vehicles, the sink vehicle 60A and the sink vehicle 60B from among the vehicles managed by the data collection system 500. For example, the data collection server 50 may acquire a history of connection to a WiFi access point from each vehicle, and may select a vehicle that is capable of repeatedly and stably communicating with the WiFi access point as the sink vehicle. A vehicle that is capable of repeatedly and stably communicating with a WiFi access point is a vehicle that is capable of performing WiFi communication during parking due to a WiFi access point being installed near a home garage, for example. Additionally, the sink vehicle may be selected from vehicles where the remaining storage capacity in the in-vehicle apparatus is great, or from vehicles where battery is not often drained during parking such as battery EVs and plug-in hybrid vehicles. In S102, the data collection server 50 transmits the notification of designation as sink vehicle to the sink vehicle 60A and the sink vehicle 60B.

In S111, the data collection server 50 selects the source vehicle 70A as the source vehicle from among vehicles that are managed by the data collection system 500. The data collection server 50 selects the source vehicle according to a predetermined policy. For example, the source vehicle is selected based on position of the vehicle, vehicle type, sensor specifications, remaining storage capacity, a history of past movement, and the like, in such a way that a density of the source vehicles becomes uniform in an area. In S112, the data collection server 50 transmits the data collection instruction to the source vehicle 70A. When the data collection instruction is received from the data collection server 50, the source vehicle 70A starts the process of uploading data.

Then, time passes, and in S121, the source vehicle 70A and the sink vehicle 60A pass each other by on a road. In S122, inter-vehicle communication is established between the source vehicle 70A and the sink vehicle 60A (FIG. 13, OP401). At this time, the source vehicle 70A and the sink vehicle 60A recognize each other as the source vehicle and the sink vehicle, and transfer of the upload data is determined. In S123, the sink vehicle 60A generates the storage capacity profile. In S124, the sink vehicle 60A transmits the storage capacity profile to the source vehicle 70A by inter-vehicle communication. The source vehicle 70A receives the storage capacity profile from the sink vehicle 60A (FIG. 13, OP402).

In S125, the source vehicle 70A determines the deletion timing of the upload data (FIG. 13, OP403). In the processes illustrated in FIGS. 14A and 14B, the source vehicle 70A holds upload data H5 and H6. Furthermore, the deletion timing is one of two stages “early” and “late”. It is assumed that the deletion timing of the upload data H5 is “early”. It is assumed that the deletion timing of the upload data H6 is “late”. In S126, the source vehicle 70A transmits the upload data H5 and H6 to the sink vehicle 60A by inter-vehicle communication (FIG. 13, OP404). The sink vehicle 60A stores the received upload data H5 and H6 in the auxiliary storage device 65.

In S127, the source vehicle 70A acquires, in relation to each upload data, the expected lifetime at the sink vehicle 60A based on the storage capacity profile of the sink vehicle 60A, the deletion timing, and the data size (FIG. 13, OP405), and determines whether to continue transmission to the sink vehicle 60 or not, based on the expected lifetime (FIG. 13, OP406). In S127, the source vehicle 70A determines end of transmission of the upload data H6 with a late deletion timing. This is because the expected lifetime of the upload data H6 at the sink vehicle 60A is longer than the expected lifetime of the upload data H5.

Then, time further passes, and in S131 in FIG. 14B, the source vehicle 70A and the sink vehicle 60B pass each other by on a road. In S132, inter-vehicle communication is established between the source vehicle 70A and the sink vehicle 60B (FIG. 13, OP401). In S133, the sink vehicle 60B generates the storage capacity profile. In S134, the sink vehicle 60B transmits the storage capacity profile to the source vehicle 70A by inter-vehicle communication. The source vehicle 70A receives the storage capacity profile from the sink vehicle 60B (FIG. 13, OP402).

In S135, the source vehicle 70A determines the deletion timing of the upload data (FIG. 13, OP403). In S136, the source vehicle 70A transmits the upload data H5 to the sink vehicle 60B by inter-vehicle communication (FIG. 13, OP404). With respect to the upload data H6, end of transmission to the sink vehicle 60 is determined in S127, and thus, the upload data H6 is not transmitted to the sink vehicle 60B. The sink vehicle 60B stores the upload data H5 that is received in the auxiliary storage device 65. Then, the source vehicle 70A acquires the expected lifetime of the upload data H5 at the sink vehicle 60B based on the storage capacity profile of the sink vehicle 60B, the deletion timing, and the data size (FIG. 13, OP405), and determines whether to continue or end transmission to the sink vehicle 60, based on the expected lifetime (FIG. 13, OP406).

Then, in S151, the sink vehicle 60A uploads the upload data H5 and H6 to the data collection server 50 by WiFi communication, for example. Then, time further passes, and in S161, the remaining storage capacity at each of the sink vehicle 60A and the sink vehicle 60B falls below the third threshold, and the upload data H5 with an early deletion timing is deleted from the storages. Additionally, in FIG. 14B, for the sake of simplicity, with respect to the upload data H5, deletion from the sink vehicle 60A and deletion from the sink vehicle 60B are collectively described, but such deletion occurs at independent timings.

In the second embodiment, in the data collection system that uses inter-vehicle communication, upload data, the deletion timing of which in a case where there is not sufficient remaining storage capacity is early, is transmitted to a greater number of sink vehicles 60. Accordingly, upload data with an early deletion timing is more likely to be uploaded to the data collection server 50. For example, in the example illustrated in FIGS. 14A and 14B, the upload data H5 with an early deletion timing is transmitted to and held by both the sink vehicle 60A and the sink vehicle 60B. In FIG. 14B, the sink vehicle 60B deletes the upload data H5 before uploading the upload data H5 to the data collection server 50. However, the sink vehicle 60A uploads the upload data H5 to the data collection server 50 before deletion, and the data collection server 50 is able to acquire the upload data H5.

Furthermore, with the sink vehicle 60, when the remaining storage capacity becomes insufficient, upload data with an early deletion timing may be deleted from the storage or may be overwritten by data of another application. Accordingly, upload data may be prevented from occupying the storage in the sink vehicle 60 and from affecting operation of other application programs. Moreover, as in the case of the distribution vehicle 2 in the first embodiment, the storage of the sink vehicle 60 may be dynamically used as a short-term cache or a long-term cache.

### <Variation of Second Embodiment>

In the second embodiment, the source vehicle 70 receives the storage capacity profile from the sink vehicle 60, and determines whether to redundantly transmit the upload data to a plurality of sink vehicles 60, based on the storage capacity profile. Instead, the data collection server 50 may regularly receive position information from the sink vehicle 60 and the source vehicle 70 and receive the storage capacity profile from the sink vehicle 60, predict a pair of the sink vehicle 60 and the source vehicle 70 that are to pass each other by, based on the position information, determine the sink vehicles 60 that are to be the transmission destinations of the upload data of the source vehicle 70 and the number of such sink vehicles 60, based on the storage capacity profile, and issue an instruction to the source vehicle 70 via a cellular network or the like.

### Other Embodiments

The embodiments described above are examples, and the present disclosure may be changed and carried out as appropriate without departing from the gist of the present disclosure.

In the first embodiment, the distribution vehicle 2 generates the storage capacity profile, but the storage capacity profile may instead be generated by the distribution server 1. In the case where the distribution server 1 generates the storage capacity profile, the distribution vehicle 2 may regularly notify the distribution server 1 of the remaining storage capacity, and the distribution server 1 may generate the storage capacity profile in the same manner as in the first embodiment based on history information about the remaining storage capacity. Also in the modification of the second embodiment, the data collection server 50 may, instead of the sink vehicle 60, generate the storage capacity profile.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to transmit, for each of one or more data blocks, a data block main body and a deletion timing to one or more first mobile bodies in such a way that the earlier the deletion timing of a data block, the greater the number of first mobile bodies as transmission destinations of the data block, wherein
each of the one or more first mobile bodies
transmits or receives one or more first data blocks among the one or more data blocks by inter-device communication,
transmits a part or all of the one or more first data blocks that is received to another apparatus, and
deletes the one or more first data blocks according to the deletion timings of each of the one or more first data blocks, depending on a remaining storage capacity.

2. The information processing apparatus according to claim 1, wherein
the processor transmits, for each of the one or more data blocks, to such a number of first mobile bodies that a total value of a first time length in the one or more first mobile bodies as the transmission destinations is approximately same between data blocks with different deletion timings, the first time length being time length that a data block is held in a first mobile body, and
the first time length is shorter when the deletion timing of the data block is earlier.

3. The information processing apparatus according to claim 2, wherein the processor estimates, for each of the one or more data blocks, the first time length in each of the one or more first mobile bodies, based on a size of a data block, the deletion timing of the data block, and estimation information about transition in the remaining storage capacity on each of the one or more first mobile bodies.

4. The information processing apparatus according to claim 3, wherein the processor receives the estimation information from each of the one or more first mobile bodies.

5. The information processing apparatus according to claim 1, wherein the processor is further configured to determine the deletion timing for each of the one or more data blocks.

6. The information processing apparatus according to claim 1, wherein
the information processing apparatus is a server, and
each of the one or more first mobile bodies transmits a part or all of the one or more first data blocks received from the server to another mobile body as the other apparatus by the inter-device communication.

7. The information processing apparatus according to claim 1, wherein
the information processing apparatus is an apparatus mounted in a mobile body, and
each of the one or more first mobile bodies
receives the one or more first data blocks from the information processing apparatus by the inter-device communication, and
transmits a part or all of the one or more first data blocks that is received to a predetermined server as the other apparatus.

8. The information processing apparatus according to claim 7, wherein the processor
estimates, for each of the one or more data blocks, based on the deletion timing of a data block, a size of the data block, and estimation information about transition in the remaining storage capacity on one first mobile body, a first time length that the data block is held in the one first mobile body, and
continues transmission of a data block for which a total value of the first time length related to one or more first mobile bodies as the transmission destinations is smaller than a predetermined threshold, and stops transmission of a data block for which the total value of the first time length is equal to or greater than the predetermined threshold.

9. A mobile body comprising a processor configured to
transmit or receive one or more first data blocks by inter-device communication, and
transmit a part or all of the one or more first data blocks that is received from a transmission source apparatus to another apparatus, wherein
the processor
receives a data block main body and a deletion timing for each of the one or more first data blocks, and
deletes the one or more first data blocks according to the deletion timings of each of the one or more first data blocks, depending on a remaining storage capacity, and
the earlier the deletion timing of a first data block, the greater the number of mobile bodies to which the first data block is transmitted.

10. The mobile body according to claim 9, wherein
the processor is further configured to
estimate transition in the remaining storage capacity based on history information about the remaining storage capacity, and
transmit estimation information including a estimation result for the remaining storage capacity to the transmission source apparatus, and
the transmission source apparatus determines to transmit the one or more first data block to at least the mobile body based on a size, the deletion timing, and the estimation information.

11. The mobile body according to claim 9, wherein
the transmission source apparatus is a server, and
the mobile body transmits a part or all of the at least one first data block received from the server to another mobile body as the other apparatus by the inter-device communication.

12. The mobile body according to claim 9, wherein
the transmission source apparatus is an apparatus mounted in a predetermined mobile body, and
the mobile body
receives the at least one first data block from the transmission source apparatus by the inter-device communication, and
transmits a part or all of the at least one first data block that is received to a predetermined server as the other apparatus.

13. A non-transitory computer-readable recording medium holding a program for causing a computer to transmit, for each of one or more data blocks, a data block main body and a deletion timing to one or more first mobile bodies in such a way that the earlier the deletion timing of a data block, the greater the number of first mobile bodies as transmission destinations of the data block, wherein
each of the one or more first mobile bodies
transmits or receives one or more first data blocks among the one or more data blocks by inter-device communication,
transmits a part or all of the one or more first data blocks that is received to another apparatus, and
deletes the one or more first data blocks according to the deletion timings of each of the one or more first data blocks, depending on a remaining storage capacity.

14. The non-transitory computer-readable recording medium according to claim 13, wherein
the program causes the computer to transmit, for each data block of the one or more data blocks, to such a number of first mobile bodies that a total value of a first time length in the one or more first mobile bodies as the transmission destinations is approximately same between data blocks with different deletion timings, the first time length being time length that a data block is held in a first mobile body, and
the first time length is shorter when the deletion timing of the data block is earlier.

15. The non-transitory computer-readable recording medium according to claim 14, wherein the program further causes the computer to estimate, for each of the one or more data blocks, the first time length in each of the one or more first mobile bodies, based on a size of a data block, the deletion timing of the data block, and estimation information about transition in the remaining storage capacity on each of the one or more first mobile bodies.

16. The non-transitory computer-readable recording medium according to claim 15, wherein the program further causes the computer to receive the estimation information from each of the one or more first mobile bodies.

17. The non-transitory computer-readable recording medium according to claim 13, wherein the program further causes the computer to determine the deletion timing for each of the one or more data blocks.

18. The non-transitory computer-readable recording medium according to claim 13, wherein
the computer is a server, and
each of the one or more first mobile bodies transmits a part or all of the one or more first data blocks received from the server to another mobile body as the other apparatus by the inter-device communication.

19. The non-transitory computer-readable recording medium according to claim 14, wherein
the computer is an apparatus mounted in a mobile body, and
each of the one or more first mobile bodies
receives the one or more first data blocks from the computer by the inter-device communication, and
transmits a part or all of the one or more first data blocks that is received to a predetermined server as the other apparatus.

20. The non-transitory computer-readable recording medium according to claim 19, wherein the program causes the computer to
estimate, for each of the one or more data blocks, based on the deletion timing of a data block, a size of the data block, and estimation information about transition in the remaining storage capacity on one first mobile body, a first time length that the data block is held in the one first mobile body, and
stop transmission of a data block for which a total value of the first time length related to the one or more first mobile bodies as transmission destinations is equal to or greater than a predetermined threshold.
